(19) United States
(12) Patent Application Publication
(10) Pub. No.: US 2017/0024738 A1
(43) Pub. Date: Jan. 26, 2017

(54) SYSTEM AND METHOD FOR ELECTRONIC PAYMENT USING PAYMENT SERVER PROVIDED TRANSACTION LINK CODES

(71) Applicant: ANAND VAIDYANATHAN, CHENNAI (IN)

(72) Inventor: ANAND VAIDYANATHAN, CHENNAI (IN)

(21) Appl. No.: 15/088,136

(22) Filed: Apr. 1, 2016

(30) Foreign Application Priority Data
Jul. 24, 2015 (IN) 3817/CHE/2015

(51) Int. Cl. G06Q 20/40

(52) U.S. Cl. CPC G06Q 20/4012; G06Q 20/40145; G06Q 2220/00

(57) ABSTRACT

A universal payment system and method for making payment transaction across different terminals and scenarios (Whether ATM, POS, E-Commerce, P2P, Mobile commerce, Social Media Commerce) without sharing payer's personal or account information with the payee is provided. The universal payment system includes a payment server to generate a transaction link code when a payer initiates a payment transaction using a payee device. The payment server communicates the generated transaction link code to the payee device. The payee device communicates the transaction link code to a payer device. The payer device receives the transaction link code and communicates to the payment server. The round trip routing of the transaction link code helps to establish the transactees in the transaction. The payment server accesses the billing information on the payee device, and communicates the billing information to the payer device for making payment.

### BACKGROUND

Technical Field

The embodiments herein generally relate to electronic payment methods for commerce and ecommerce, and, more particularly, a system and method for electronic payment using payment server provided transaction link codes.

Description of the Related Art

As electronic financial transactions have expanded, exemplified by the widespread use of credit cards for nearly all types of both direct and electronic commerce, so too has the risk of fraudulent financial transactions also expanded. Although much prior effort in security has been devoted to foiling sophisticated “man in the middle” attacks through the use of secure and encrypted communications channels, the simple fact remains that there is almost no defense against low-technology fraud. It is simply all too easy, for example, for an unscrupulous store clerk to write down a customer's credit card number, and then quickly ring up hundreds or even thousands of money in unauthorized charges on this card later.

The problem is bad enough when a customer is engaging in face to face transactions at a store counter, but at least there the customer can watch the clerk, and potentially identify the clerk later if necessary. By contrast, when the transaction takes place at a distance, such as by phone or by internet, the customer can't watch the clerk, and has no way at all to identify the clerk.

As a result, many individuals are leery of engaging in long distance electronic financial transactions. Although many financial agencies, such as credit card companies, do have a process for tracking down fraud and reimbursing the customer for fraudulent transactions, the process is slow and painful, as well as adding to the overall financial costs (i.e. overall credit card fees, and the like) to the system.

In an effort to resolve this type of problem, there have been a number of efforts to devise various types of electronic payment systems, exemplified by Paypal and Ericsson IPX mobile payments.

In one such scheme, exemplified by PayPal, the payer (i.e. customer) creates an account with a PayPal network payment server that is generally accessed through the network payment server's client interface (e.g. the PayPal payment server's web browser, or a PayPal linked auction website such as eBay, and the like). The PayPal network payment server then links the payer's account to the payer's credit card, bank account, or other existing source of funds, and also generates a PayPal payee ID (PayPal ID, often based on the payee's email). The payer then pays the payee using his PayPal ID for payment.

The PayPal system is useful for online purchases, but since the PayPal account information (e.g. the user's email, the user's PayPal account ID) continues to be both persistent and sensitive, there are still security concerns. For example, malicious websites which may present a dummy “Paypal look-alike” site for accepting payments. Separately, this system requires entering account information and hence is not as convenient for the user. Furthermore, this system is not suitable for making payments for in-store purchases.

In an alternative approach that is used by some mobile payment services providers, for example Ericsson IPX, to purchase online goods, the payer (i.e. customer) provides a mobile phone number to payee, which then presents the phone number to the Ericcson payment system. The payment system in-turn provides the payer with a passcode number (PIN). The payer gives this PIN to the merchant (payee). Upon receiving this PIN, the payee (merchant) then releases the on-line goods. The payment funds ultimately come from the payer's mobile phone bill.

The drawback of this approach is payer needs to share his personal information, for example phone number with the payee (merchant) site. Separately this process is bit inconvenient for the payer since he has to first enter information on the payee site and then read PIN from his cell phone, and then enter PIN into payee's online site.

Further, the method of making payment transaction may vary across terminals from e-commerce, peer to peer present (P2P) transaction, Automated Teller Machine (ATM), Point of Sale (POS) terminals, mobile to mobile transaction, Social networking commerce, and m-commerce. Accordingly, there remains a need for a universal payment system and method for making payment transaction across different terminals without sharing payer's personal information.

### SUMMARY

In view of the foregoing, an embodiment herein provides a payment server for authenticating a transaction between a payer device and a payee device. The payment server includes a memory unit, and a processor. The memory unit that stores (a) a set of modules, and (b) a historical database. The processor which executes the set of modules. The set of modules includes a request processing module, a payee account identification module, a transaction link code generation module, a transaction link code receiving module, a directory service referencing module, a payment details obtaining module, a payment details communicating module, a payer account identification module, a payment authorization module, a payment receiving module, a payment transferring module, and a payment confirmation module. The request processing module, executed by the processor, configured to receive a request from a payee for a transaction link code. The payee account identification module, executed by the processor, configured to communicate with a directory service to identify bank account details of the payee. The transaction link code generation module, executed by the processor, configured to generate the transaction link code. The transaction link code generation module communicates the transaction link code to the payee device. The transaction link code receiving module, executed by the processor, configured to receive the transaction link code from the payer device. The directory service referencing module, executed by the processor, configured to communicate with the directory service to identify (a) a bank account of the payee based on a device ID of the payee device, and (a) one or more bank accounts of a payer based on a device ID of the payer device. The payment details obtaining module, executed by the processor, configured to communicate with the payee device to obtain payment details for the payer. The payment details communicating module, executed by the processor, configured to communicate (a) the one or more bank accounts of the payer, and (b) the payment details to the payer device for making a payment transaction. The payer account identification module, executed by the processor, configured to receive at least one of (i) an encrypted PIN of a selected bank account from the payer device, and (b) a biometric parameter of the payer. The payment authorization module, executed by the processor, configured to authorize the payment transaction by confirming a payment amount available in the selected bank account of the payer. The payment receiving module, executed by the processor, configured to communicate with a payer bank server to receive the payment amount that is approved by the payer using the payer device. The payment transferring module, executed by the processor, configured to communicate with a payee bank server to transfer the payment amount received from the payer bank server. The payment confirmation module, executed by the processor, configured to communicate a confirmation message to (a) the payer device, and (b) the payee device on receipt of the payment amount.

In one embodiment, the directory service (i) stores identity information of the payee and the payer, (ii) establishes the payer and the payee. The directory service includes a memory unit, and a processor. The memory unit that stores (a) a set of modules, and (b) a historical database. The processor which executes the set of modules. The set of modules includes a bank accounts registration module, an account information obtaining module, a payee account information communication module, and a payer account information communication module. The bank accounts registration module, executed by the processor, configured to provide an option to (a) the payee bank server, and (b) the payer bank server to register with the directory service. The account information obtaining module, executed by the processor, configured to obtain account information of (a) the payee from the payee bank server, and (b) the payer from the payer bank server. The payee account information communication module, executed by the processor, configured to communicate the account information of the payee with the payment server when the payment server requests the directory service. The payer account information communication module, executed by the processor, configured to communicate the account information of the payer with the payment server when the payment server requests the directory service.

In another embodiment, the payee device includes a memory, and a processor. The memory unit that stores (a) a set of modules, and (b) a database. The processor which executes the set of modules. The set of modules includes a payment transaction initiating module, a payee device ID module, a transaction link code receiving module, a transaction link code transmitting module, a payment details transmitting module, and a payee transaction confirmation message receiving module. The payment transaction initiating module, executed by the processor, configured to communicate a request for the transaction link code to the payment server to initiate the payment transaction. The payee device ID module, executed by the processor, configured to communicate the device ID of the payee device along with the request to the payment server. The transaction link code receiving module, executed by the processor, configured to receive the transaction link code from the payment server. The transaction link code transmitting module, executed by the processor, configured to display or transmit the transaction link code to the payer device. The payment details transmitting module, executed by the processor, configured to (a) receive a request for payment details from the payment server, and (b) transmits the payment details to the payment server. The payee transaction confirmation message receiving module, executed by the processor, configured to receive a confirmation message from the payment server when the payee bank server receives the payment amount from the payment server.

In yet another embodiment, the payer device includes a memory unit, and a processor. The memory unit that stores (a) a set of modules, and (b) a database. The processor which executes the set of modules. The set of modules includes a transaction link code reading module, a transaction link code communicating module, a payer device ID module, a payment details receiving module, a bank accounts detail displaying module, a pin or account validation communication module, a payer validation module, and a payer transaction confirmation message receiving module. The transaction link code reading module, executed by the processor, configured to receive or read the transaction link code from the payee device. The transaction link code communicating module, executed by the processor, configured to communicate the transaction link code to the payment server. The payer device ID module, executed by the processor, configured to communicate the device ID of the payer device along with the transaction link code to the payment server. The payment details receiving module, executed by the processor, configured to receive the payment details from the payment server to make the payment transaction. The bank accounts detail displaying module, executed by the processor, configured to provide the one or more bank accounts to the payer to select a bank account to make the payment transaction. The pin or account validation communication module, executed by the processor, configured to communicate an encrypted PIN of the selected bank account to the payment server. The payer validation module, executed by the processor, configured to validate the payer when the payer provides at least one of (i) an encrypted PIN of the selected bank account, and (b) a biometric parameter of the payer. The payer transaction confirmation message receiving module, executed by the processor, configured to receive a confirmation message from the payment server on receipt of the payment amount approved by the payer from the payer bank server.

In yet another embodiment, the historical database of the payment server stores transaction data and transaction numbers which can be called upon by the payment sever in case of chargebacks and to resolve any disputes or enquiries. The historical database keeps a record of all transactions for future reference by the payment server. In yet another embodiment, the payment server provides the payee with payer information and purchase details so that the payee can tailor loyalty programs and perform marketing analytics on sales data and payer profiles. In yet another embodiment, the directory service does not store account amount details of the payee, or the payer which enhances privacy. The payer device does not store bank account number information of the payer in an encrypted or an unencrypted form on a mobile phone, which prevents hacking and fraud. In yet another embodiment, the payer is authorized by an encrypted PIN in a 2-factor authentication scenario, and a 3-factor authentication/the biometric parameter. The 2-factor authentication is a PIN number. The 3-factor authentication is a finger print, voice recognition, or facial recognition. A 1-factor in authentication is something the payer has which is the payer mobile phone. The 2-factor authentication is something the payer knows or carries in head. The 3-factor authentication may be something that the payer is which is a biometric identification. In yet another embodiment, the payment server tags (i) the device ID of the payee device (ii) the device ID of the payer device, and (iii) account descriptions to the transaction link code to generate a transaction number for the payment transaction. In yet another embodiment, the transaction link code may be a QR code, or a Near field communication (NFC) code. In yet another embodiment, the payer device may be an ATM. In yet another embodiment, the payer device communicates with at least one of: (i) an E-commerce server, (ii) an M-commerce server, (iii) a point of sale terminal, (iv) a social networking website, and (v) another payer in a peer to peer present transaction of the payee device to perform the payment transaction. In yet another embodiment, the payment server provides an e-receipt to the payer device with details of entire transaction to track a budget of the payer. In yet another embodiment, the E-commerce and M-commerce servers directly accesses the payer details such as shipping address from the payment server (which accesses it from the payer) to make the payment transaction. The E-commerce server eliminates the payer to login to an E-commerce website to make the payment transaction.

In another aspect, a universal payment system for authenticating a transaction between a payer and a payee without sharing account identification information of a payer to a payee or vice versa is provided. The universal payment system includes a payment server, a payee device, and a payer device. The payment server includes a memory unit, and a processor. The memory unit that stores (a) a set of modules, and (b) a historical database. The processor which executes the set of modules. The set of modules includes a request processing module, a payee account identification module, a transaction link code generation module, a transaction link code receiving module, a directory service referencing module, a payment details obtaining module, a payment details communicating module, a payer account identification module, a payment authorization module, a payment receiving module, a payment transferring module, and a payment confirmation module. The request processing module, executed by the processor, configured to receive a request from a payee for a transaction link code. The payee account identification module, executed by the processor, configured to communicate with a directory service to identify bank account details of the payee. The transaction link code generation module, executed by the processor, configured to generate the transaction link code. The transaction link code generation module communicates the transaction link code to the payee device. The transaction link code receiving module, executed by the processor, configured to receive the transaction link code from the payer device. The directory service referencing module, executed by the processor, configured to communicate with the directory service to identify (a) a bank account of the payee based on a device ID of the payee device, and (a) one or more bank accounts of a payer based on a device ID of the payer device. The payment details obtaining module, executed by the processor, configured to communicate with the payee device to obtain payment details for the payer. The payment details communicating module, executed by the processor, configured to communicate (a) the one or more bank accounts of the payer, and (b) the payment details to the payer device for making a payment transaction. The payer account identification module, executed by the processor, configured to receive at least one of (i) an encrypted PIN of a selected bank account from the payer device, and (b) a biometric parameter of the payer. The payment authorization module, executed by the processor, configured to authorize the payment transaction by confirming a payment amount available in the selected bank account of the payer. The payment receiving module, executed by the processor, configured to communicate with a payer bank server to receive the payment amount that is approved by the payer using the payer device. The payment transferring module, executed by the processor, configured to communicate with a payee bank server to transfer the payment amount received from the payer bank server. The payment confirmation module, executed by the processor, configured to communicate a confirmation message to (a) the payer device, and (b) the payee device on receipt of the payment amount. The payee device includes a memory unit, and a processor. The memory unit that stores (a) a set of modules, and (b) a database. The processor which executes the set of modules. The set of modules includes a payment transaction initiating module, a payee device ID module, a transaction link code receiving module, a transaction link code transmitting module, a payment details transmitting module, and a payee transaction confirmation message receiving module. The payment transaction initiating module, executed by the processor, configured to communicate a request for the transaction link code to the payment server to initiate the payment transaction. The payee device ID module, executed by the processor, configured to communicate the device ID of the payee device along with the request to the payment server. The transaction link code receiving module, executed by the processor, configured to receive the transaction link code from the payment server. The transaction link code transmitting module, executed by the processor, configured to display or transmit the transaction link code to the payer device. The payment details transmitting module, executed by the processor, configured to (a) receive a request for payment details from the payment server, and (b) transmits the payment details to the payment server. The payee transaction confirmation message receiving module, executed by the processor, configured to receive a confirmation message from the payment server when the payee bank server receives the payment amount from the payment server. The payer device includes a memory unit, and a processor. The memory unit that stores (a) a set of modules, and (b) a database. The processor which executes the set of modules.

The set of modules includes a transaction link code reading module, a transaction link code communicating module, a payer device ID module, a payment details receiving module, a bank accounts detail displaying module, a pin or account validation communication module, a payer validation module, and a payer transaction confirmation message receiving module. The transaction link code reading module, executed by the processor, configured to receive or read the transaction link code from the payee device. The transaction link code communicating module, executed by the processor, configured to communicate the transaction link code to the payment server. The payer device ID module, executed by the processor, configured to communicate the device ID of the payer device along with the transaction link code to the payment server. The payment details receiving module, executed by the processor, configured to receive the payment details from the payment server to make the payment transaction. The bank accounts detail displaying module, executed by the processor, configured to provide the one or more bank accounts to the payer to select a bank account to make the payment transaction. The pin or account validation communication module, executed by the processor, configured to communicate encrypted PIN of the selected bank account to the payment server. The payer validation module, executed by the processor, configured to validate the payer when the payer provides at least one of (i) an encrypted PIN of the selected bank account, and (b) a biometric parameter of the payer. The payer transaction confirmation message receiving module, executed by the processor, configured to receive a confirmation message from the payment server on receipt of the payment amount approved by the payer from the payer bank server.

In one embodiment, the directory service (i) stores identity information of the payee and the payer, (ii) establishes the payer and the payee. The directory service includes a memory unit, and a processor. The memory unit that stores (a) a set of modules, and (b) a database. The processor which executes the set of modules. The set of modules includes a bank accounts registration module, an account information obtaining module, a payee account information communication module, and a payer account information communication module. The bank accounts registration module, executed by the processor, configured to provide an option to (a) the payee bank server, and (b) the payer bank server to register with the directory service. The account information obtaining module, executed by the processor, configured to obtain account information of (a) the payee from the payee bank server, and (b) the payer from the payer bank server. The payee account information communication module, executed by the processor, configured to communicate the account information of the payee with the payment server when the payment server requests the directory service. The payer account information communication module, executed by the processor, configured to communicate the account information of the payer with the payment server when the payment server requests the directory service. The payer device may be an ATM. The payer device communicates with at least one of: (i) an E-commerce server, (ii) an M-commerce server, (iii) a point of sale terminal, (iv) a social networking website, and (v) another payer in a peer to peer present transaction of the payee device to perform the payment transaction.

In another embodiment, the payment server separately communicates with the payee and the payer to make the payment transaction. The entire payment transaction is performed in a cloud. In yet another embodiment, the payment server tags (i) the device ID of the payee device (ii) the device ID of the payer device, and (iii) account descriptions to the transaction link code to generate a transaction number for the payment transaction. In yet another embodiment, the payment server provides an e-receipt to the payer device with details of entire transaction to track a budget of the payer.

In yet another aspect, a method for authenticating a transaction between a payer and a payee using a payment server is provided. The method includes the following steps: (i) receiving, using a request processing module, a request from a payee for a transaction link code; (ii) communicating, using a payee account identification module, with a directory services to identify bank account details of the payee; (ii) generating, using a transaction link code generation module, the transaction link code; (iv) receiving, using a transaction link code receiving module, the transaction link code from a payer device; (v) identifying, using a directory services referencing module, pending validation of the payer by communicating with the directory services; (vi) communicating, using a payment details obtaining module, with a payee device to obtain payment details for the payer; (vii) communicating, using a payment detail communicating module, (a) one or more bank accounts of the payer, and (b) the payment details to the payer device for making a payment transaction; (viii) receiving, using a payer account identification module, at least one of (a) an encrypted pin of a selected bank account from the payer device, and (b) a biometric parameter of the payer; (ix) authorizing, using a payment authorization module, the payment transaction by confirming a payment amount available in the selected bank account of the payer; (x) communicating, using a payment receiving module, with a payer bank server to receive the payment amount that is approved by the payer using the payer device; (xi) communicating, using payment transferring module, with a payee bank server to transfer the payment amount received from the payer bank server; and (xii) communicating, using a payment confirmation module, a confirmation message to (a) the payer device, and (b) the payee device on receipt of the payment amount.

In one embodiment, the method includes the following steps performed by the payee device: (i) communicating, using a payment transaction initiating module, the request for the transaction link code to the payment server to initiate the payment transaction; (ii) communicating, using a payee device id module, a device id of the payee device along with the request to the payment server; (iii) receiving, using a transaction link code receiving module, the transaction link code from the payment server; (iv) displaying or transmitting, using a transaction link code transmitting module, the transaction link code to the payer device; (v) receiving, using a payment details transmitting module, a request for payment details from the payment server; (vi) transmitting, using the payment details transmitting module, the payment details to the payment server; and (vii) receiving, using a payee transaction confirmation message receiving module, a confirmation message from the payment server when the payee bank server receives the payment amount from the payment server.

In another embodiment, the method includes the following steps performed by the payer device: (i) reading, using a transaction link code reading module, the transaction link code from the payee device and creates an atmosphere for the payment transaction; (ii) communicating, using a transaction link code communicating module, the transaction link code to the payment server; (iii) communicating, using a payer device id module, a device id of the payer device along with the transaction link code to the payment server; (iv) receiving, using a payment details receiving module, the payment details from the payment server to make the payment transaction; (v) providing, using a bank accounts detail displaying module, the one or more bank accounts to the payer to select a bank account to make the payment transaction; (vi) communicating, using a pin or account validation communication module, an encrypted pin of a selected bank account to the payment server; (viii) validating, using a payer validation module, the payer when the payer provides at least one of (i) an encrypted pin of the selected bank account, and (b) a biometric parameter of the payer; and (ix) receiving, using a confirmation message receiving module, a confirmation message from the payment server on receipt of the payment amount approved by the payer from the payer bank server.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 illustrates a system view of a payee interacting with a payer through a payment server for performing a payment transaction according to an embodiment herein;

FIG. 2A illustrates an exploded view of a payment server of FIG. 1 according to an embodiment herein;

FIG. 2B illustrates an exploded view of a directory service of FIG. 1 according to an embodiment herein

FIG. 3 illustrates an exploded view of a payee device of FIG. 1 according to an embodiment herein;

FIG. 4 illustrates an exploded view of a payer device of FIG. 1 according to an embodiment herein;

FIG. 5 illustrates an exemplary view of an Automated Teller Machine (ATM) interacting with a payee through a payment server to perform a payment transaction according to an embodiment herein;

FIG. 6 illustrates an exemplary view of an E-commerce server interacting with a payer through a payment server to perform a payment transaction according to an embodiment herein;

FIG. 7 illustrates an exemplary view of an M-commerce server interacting with a payer through a payment server to perform a payment transaction according to an embodiment herein;

FIG. 8 illustrates an exemplary view of a Point of Sale (POS) terminal interacting with a payer through a payment server to perform a payment transaction according to an embodiment herein;

FIG. 9 illustrates an exemplary view of a social networking website interacting with a payer through a payment server to perform a payment transaction according to an embodiment herein;

FIG. 10 illustrates an exemplary view of a peer to peer present transaction according to an embodiment herein;

FIG. 11 illustrates an exemplary view of a mobile to mobile transaction according to an embodiment herein;

FIGS. 12A and 12B are flow diagrams illustrating a method of communication between a payee device and a payer device through a payment server of FIG. 1 according to an embodiment herein;

FIG. 13 is a flow diagram illustrating a method of a payee device communicates with a payment server and a payer device of FIG. 1 according to an embodiment herein;

FIG. 14 is a flow diagram illustrating a method of a payer device communicates with a payment server and a payee device of FIG. 1 according to an embodiment herein;

FIG. 15 illustrates an exploded view of a personal communication device according to the embodiments herein; and

FIG. 16 a schematic diagram of computer architecture used in accordance with the embodiment herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

As mentioned, there remains a need for a universal payment system and method for making payment transaction across different terminals (e.g., e-commerce, P2P, ATM, POS terminals, Social networking commerce, and m-commerce) without sharing payer's personal information. The embodiments herein achieve this by providing an electronic payment system that includes a payment server for generating a transaction link code. The transaction link code is generated by the payment server when a payer initiates a payment transaction using a payee device. The payment server communicates the generated transaction link code to the payee device. The payee device communicates the transaction link code to a payer device. The payer device receives the transaction link code and communicates to the payment server. The round trip routing of the transaction link code helps to establish the transactees (i.e. the payee, and the payer in the transaction). The payment server acts as a mediator to communicate between the payee device, and the payer device. The payment server accesses the billing information on the payee device, and communicates the billing information to the payer device for making payment. The payer device makes the payment without sharing bank account identification details to the payee.

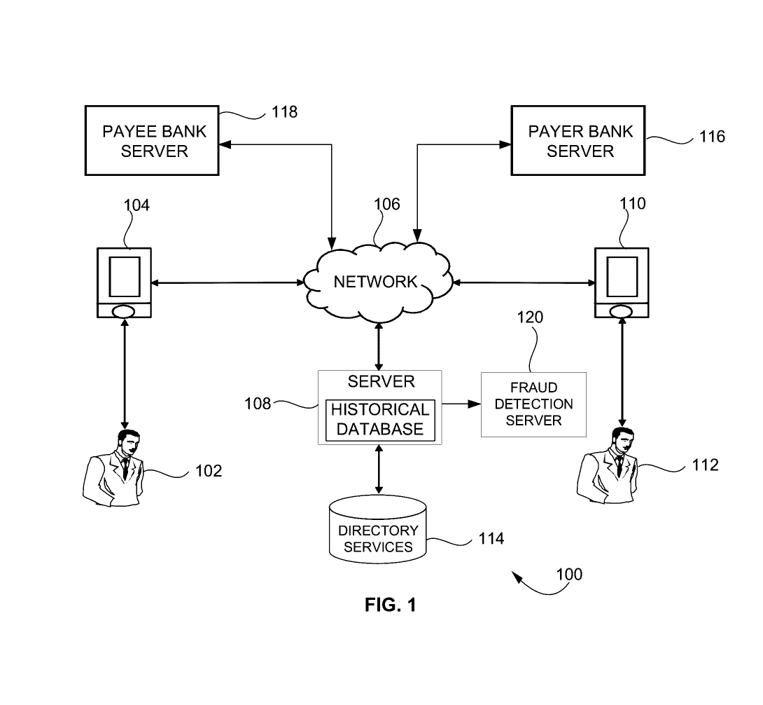

Referring now to the drawings, and more particularly to FIG. 1 through FIG. 16, where similar reference characters denote corresponding features consistently throughout the figures, there are shown preferred embodiments.

FIG. 1 illustrates a system view 100 of a payee 102 interacting with a payer 112 through a payment server 108 for performing a payment transaction according to an embodiment herein. The system view 100 includes a payee device 104, a payer device 110, a network 106, directory service 114, a payer bank server 116, a payee bank server 118, and a fraud detection server 120. The payee 102 interacts with the payer 112 through the network 106 provided by the payment server 108. The payee 102 interacts with the payer 112 through a network 106 using the payee device 104 (e.g., a Smart phone, Point of sale (POS) terminal, a Computer or both, or such computation devices). The payer device 110 may be a smart phone, a computer or both or such computation devices. The payment server 108 establishes a communication with the payee device 104 and the payer device 110 by a pre-established device ID/account ID. The device ID is established to the payee device 104, and the payer device 110 at the time of installing a payment application on the respective devices. In one embodiment, the payee 102, and the payer 112 communicates a name, and a phone number to the payment server 108 while installing a payment application to create a device ID. In another embodiment, the payment application on the payee 102, and the payer 112 may be an Application Program

Interface (API) or Application. The device ID may be a Machine fingerprint, a mobile number, and other device identification parameters. In one embodiment, the device ID is a mobile number in case of the payee device 104, and the payer device 110 as a mobile phone. Once the device ID is created, the payment server 108 communicates with the directory service 114 to validate the payee 102, and the payer 112 account details (i.e. credit/debit account). In one embodiment, the payment server 108 communicates with the directory service 114 to check whether the payee 102, and the payer 112 account is established with the directory service 114. The directory service 114 provide the repository of the account details (sans any balance details) of the payee 102, and the payer 112, who's banks are enrolled with the directory service 114 as member banks. In one embodiment, the device ID of the payee 102 and the payer 112 may be registered in the directory service 114. Once the device IDs of the payee device 104, and the payer device 110 is validated by the payment server 108, the payment server 108 communicates with the directory service 114 to obtain account identification details (i.e. name of customer, bank, credit/debit account number etc) to interact with the payer bank server 116, and the payee bank server 118 to obtain details of one or more bank accounts (e.g., credit/debit/savings/current/ATM card) and available balance information of the payee 102, and the payer 112 based on the device IDs of the payee 102 and the payer 112. In one embodiment, the payment server 108 includes the directory service 114 that store a name and a phone number of the payee 102, and the payer 112, and the device ID of the payee device 104, and the payer device 110. In another embodiment, the directory service 114 may stores details of the one or more bank accounts of the payee 102 (e.g., Merchant) and payer 112 (e.g., Customer). In another embodiment, when the payee 102 or the payer 112 opens a bank account with a bank, the payee 102, or the payer 112 may request the bank to provide the bank account details to the directory service 114. The payment server 108 communicates one or more bank accounts of the payer 112 to the payer device 110 when the payment server 108 receives the transaction link code along with the device ID of the payer 112 from the payer device 110. The payer 112 activates a particular bank account provided in the payer device 110 by entering respective personal identification number (PIN) of the bank account to make the payment transaction. The payment server 108 initiates the transaction by receiving the payment amount from the payer bank server 116. The payment server 108 communicates the payee bank server 118 to credit the payment amount to a payee bank account. Finally the payment server 108 communicates a confirmation message to the payee device 104, and the payer device 110 on receipt of the payment amount. In one embodiment, the payment transaction includes the 3 processes as follows: (i) Authorization, (ii) Capture, and (iii) Settlement. The settlement transactions (i.e. payment transaction) maybe through an ‘ACH’ (Automated Clearing House) at the end of the day done in a batch file in one other embodiment.

When the payer 112 is billed at the payee device 104 (e.g., a POS terminal), the payee 102 initiates a payment transaction by requesting the transaction link code to the payment server 108 along with a device ID of the payee device 104. The payment server 108 identifies the payee 102 using the device ID and by communicating with the directory service 114. The payment server 108 generates the transaction link code and communicates the transaction link code to the payee device 104. The payment server 108 (a) tags (i) the device ID of the payee device 104 and the payer device 110, and (ii) account descriptions to the transaction link code, and (b) generates the transaction number for the payment transaction. In one embodiment, the payment server 108 stores the transaction number along with the device ID of the payee 102. The payment server 108 communicates with the directory service 114 to identify the payee account using the device ID. The payment server 108 communicates the transaction link code to the payee device 104. The payee device 104 receives the transaction link code and transmits the transaction link code to the payer 112. In one embodiment, the transaction link code may be a QR code, or a Near field communication (NFC) code. In another embodiment, the transaction link code may include transactional details such as payment amount to reduce the latency period for the payment transaction by reducing the number of steps involved in the payment transaction.

The payer device 110 receives the transaction link code from the payee device 104 and reads the transaction link code using the payment application. The payer device 110 communicates the transaction link code to the payment server 108 along with the device ID of the payer device 110. The payment server 108 receives the transaction link code from the payer device 110 and identifies the device ID of the payer device 110. In one embodiment, the payment server 108 communicates with the directory service 114 to identify the payer 112 using the device ID. In another embodiment, the payment server 108 communicates with the directory service 114 to obtain the one or more bank accounts for the device ID (e.g. for payer 112 device ID). The payment server 108 communicates with the payee device 104 to obtain payment details for the payer 112. The payment server 108 communicates the payment details to the payer device 110 for making payment. The payer device 110 provides the one or more bank accounts to the payer 112 to make the payment. The payer 112 selects a bank account (e.g., credit card, debit card or other payments accounts) and enters the corresponding PIN number. The payer device 110 communicates the bank account, and encrypted PIN of the selected bank account to the payment server 108. The payment server 108 authorizes the payment transaction by confirming the payment amount (that is billed at the payee device 104) available in the selected bank account of the payer 112. In one embodiment, the payment server 108 communicates with the payer bank server 116 to confirm the payment amount (that is billed at the payee device 104) available in the bank account of the payer 112. The payment server 108 communicates with the payer bank server 116 of the payer 112 to receive the payment amount that is approved by the payer 112 using the payer device 110. The payer 112 confirms the payment transaction by a 2-factor authentication, or a 3-factor authentication method, and the payment is transacted through the payment server 108. In one embodiment, the 2-factor authentication is a PIN number (i.e. a password for the account, or an one time password). In another embodiment, a biometric or a 3-factor authentication may be a finger print, voice recognition, and facial recognition. In yet another embodiment a 1-factor in authentication is something said payer has which is said payer mobile phone. The payment server 108 communicates with the payee bank server 118 to transfer the payment amount that is billed at the payee device 104 for the payer 112. The payment server 108 communicates a confirmation message to the payer device 110 on receipt of the payment amount approved by the payer 112 from the selected bank account of the payer 112. In one embodiment, the payment server 108 communicates a confirmation message to the payee device 104 that the payment is received successfully. In another embodiment, the payee 102 may open a financial account with the payment server 108 instead of the bank. In yet another embodiment, the payment server 108 includes a historical database that stores the transaction number in accorded to the payment transaction, and details of the payment transaction. The payment server 108 communicates with the fraud detection server 120 to detect any unusual patterns of transaction or patterns related to fraudulent transaction to forestall any unauthorized transaction while initiating the transaction. In one embodiment, the payee 102 provides a loyalty program to the payer 112.

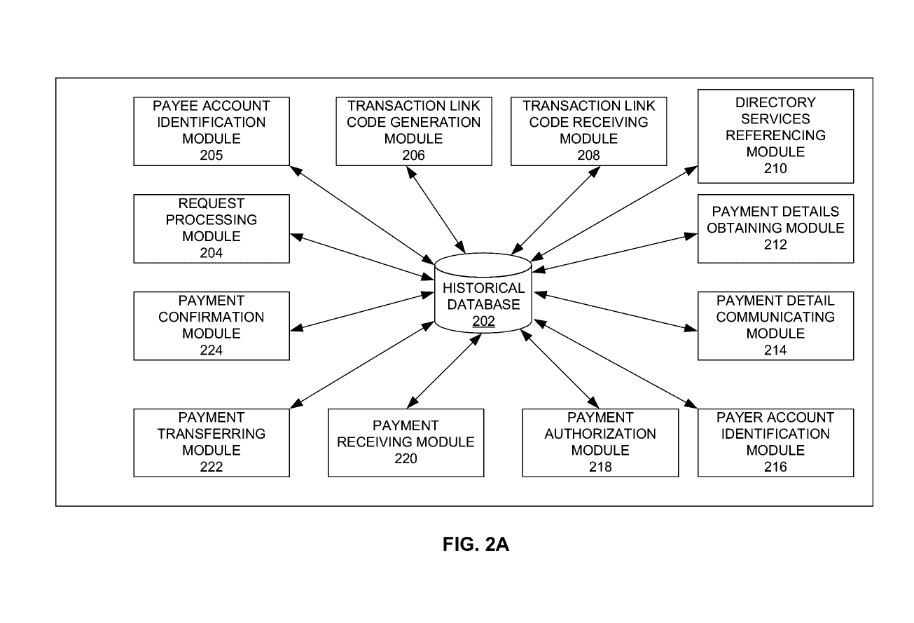

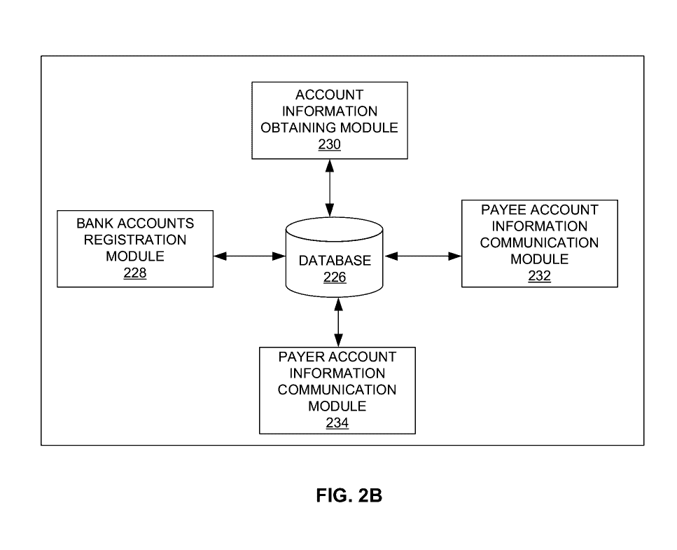

FIG. 2A illustrates an exploded view of a payment server 108 of FIG. 1 according to an embodiment herein. The payment server 108 includes a historical database 202, a request processing module 204, a payee account identification module 205, a transaction link code generation module 206, a transaction link code receiving module 208, a directory service referencing module 210, a payment details obtaining module 212, a payment detail communicating module 214, a payer account identification module 216, a payment authorization module 218, a payment receiving module 220, a payment transferring module 222, and a payment confirmation module 224. The historical database 202 stores transaction details of all transactions done in any configuration includes details such as accounts involved in transaction, time and date of transaction, amounts of transaction, banks involved and type of transaction whether point of sale (POS), peer to peer (P2P), ATM, E-Commerce, M-commerce, Social network etc. In one embodiment, the historical database of the payment server 108 stores non-identifiable information of the payer 112 for marketing studies and analytics. In another embodiment, the payee device 104 may be a smart phone, Point of sale (POS) terminal, a computer or both, or such computation devices. In yet another embodiment, the payer device 110 may be a smart phone, a computer or both, or such computation devices. The request processing module 204 is configured to receive a request from the payee 102 for a transaction link code. The payee account identification module 205 is configured to communicate with the directory service 114 to identify bank account details of the payee 102. The transaction link code generation module 206 is configured to generate the transaction link code. The transaction link code generation module 206 communicates the transaction link code to the payee device 104. The transaction link code receiving module 208 is configured to receive the transaction link code from the payer device 110. The directory service referencing module 210 is configured to communicate with the directory service 114 to identify (a) a bank account of the payee 102 based on the device ID of the payee device 104, and (a) one or more bank accounts of the payer 112 based on the device ID of the payer device 110. The directory service referencing module 210 is configured to identify pending validation of the payer 112 by communicating with the directory services 114. The payment details obtaining module 212 is configured to communicate with the payee device 104 to obtain payment details (i.e. payment amount) for the payer 112. The payment detail communicating module 214 is configured to communicate (a) the one or more bank accounts of the payer 112, and (b) the payment details to the payer device 110 for making a payment transaction. The payer account identification module 216 is configured to receive at least one of (i) an encrypted PIN of a selected bank account from the payer device 110, and (b) a biometric parameter of the payer 112. In one embodiment, the biometric parameters may be a finger print, voice recognition, and facial recognition. The payment authorization module 218 is configured to authorize the payment transaction by confirming the payment amount available in the selected bank account of the payer 112. The payment receiving module 220 is configured to communicate with the payer bank server 116 to receive the payment amount that is approved by the payer 112 using the payer device 110. The payment transferring module 222 is configured to communicate with the payee bank server 118 to transfer the payment amount received from the payer bank server 116. The payment confirmation module 224 is configured to communicate a confirmation message to (a) the payer device 110, and (b) the payee device 104 on receipt of the payment amount. In one embodiment, the payment server 108 separately communicates with the payee 102 and the payer 112 to make the payment transaction. The entire payment transaction is performs in a cloud. In one embodiment, the payment server 108 provides an e-receipt to the payer device 110 with details of entire transaction to help payer 112 budget and track the expenses.

FIG. 2B illustrates an exploded view of a directory service 114 of FIG. 1 according to an embodiment herein. The directory service 114 includes a database 226, a bank accounts registration module 228, an account information obtaining module 230, a payee account information communication module 232, and a payer account information communication module 234. The database 226 includes a name of the payee 102, a name of the payer 112, bank names of the payee 102, and the payer 112, branch name of the bank, type of account, account identification details (credit/debit/savings/current/OD etc) and a phone number or device ID of the payee 102, and the payer 112 etc. In one embodiment, the directory service 114 does not store account amount details of the payee 102, or the payer 112. The bank accounts registration module 228 is configured to provide an option to (a) the payee bank server 118, and (b) the payer bank server 116 to register with the directory service 114. The account information obtaining module 230 is configured to obtain account information of (a) the payee 102 from the payee bank server 118, and (b) the payer 112 from the payer bank server 116. In one embodiment, the account information includes (i) a name of the payee 102 and the payer 112, (ii) a phone number of the payee 102 and the payer 112, (iii) a bank name of the payee 102, (iv) a bank name of the payer 112, (v) a branch name of the payee bank, (vi) a branch name of the payer bank, (vii) a bank account type of the payee 102, and (viii) a bank account type of the payer 112 (ix) account identifying information of the payee 102 (x) account identifying information of the payer 112. The payee account information communication module 232 is configured to communicate the account information of the payee 102 with the payment server 108 when the payment server 108 requests the directory service 114. The payer account information communication module 234 is configured to communicate the account information of the payer 112 with the payment server 108 when the payment server 108 requests the directory service 114.

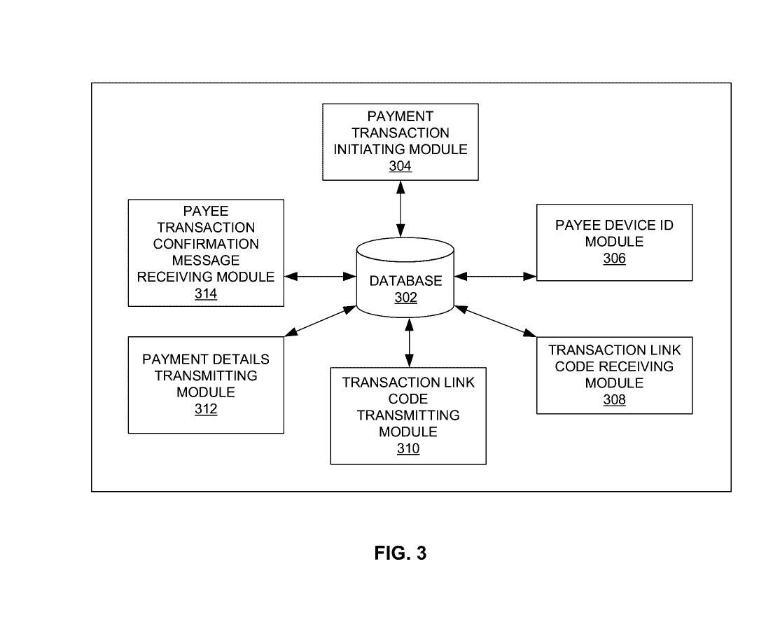

FIG. 3 illustrates an exploded view of a payee device 104 of FIG. 1 according to an embodiment herein. The payee device 104 includes a database 302, a payment transaction initiating module 304, a payee device Id module 306, a transaction link code receiving module 308, a transaction link code transmitting module 310, a payment details transmitting module 312, and a payee transaction confirmation message receiving module 314. The database 302 stores a device ID of the payee device 104, a name of the payee 102, bank names of the payee 102, and the payer 112, branch name of the bank, type of account, account identification details (credit/debit/savings/current/OD etc) of the payee 102 (e.g., Merchant) etc. The database 302 may or may not have an account number of the payee 102, and the payer 112. The payment transaction initiating module 304 is configured to communicate a request for a transaction link code to the payment server 108 to initiate the payment transaction. The payee device ID module 306 is configured to communicate a device ID of the payee device 104 along with the request to the payment server 108. The transaction link code receiving module 308 is configured to receive the transaction link code from the payment server 108. In one embodiment, payment server 108 tags the device ID/account ID of the payee device 104 to the transaction link code and generate a transaction number for the payment transaction. In another embodiment, the transaction number is stored in the historical database 202. The transaction link code transmitting module 310 is configured to display or transmit the received transaction link code to the payer device 110. In one embodiment, the transaction link code may be a QR code, or a Near field communication (NFC) code. In another embodiment, the transaction link code may include transactional details such as payment amount to reduce the latency period for the payment transaction by reducing the number of steps involved in the payment transaction. The payment details transmitting module 312 is configured to (a) receive the request for payment details from the payment server 108, and (b) transmits the payment details to the payment server 108. The payee transaction confirmation message receiving module 314 is configured to receive a confirmation message from the payment server 108 when the payee bank server 118 receives the payment amount from the payment server 108.

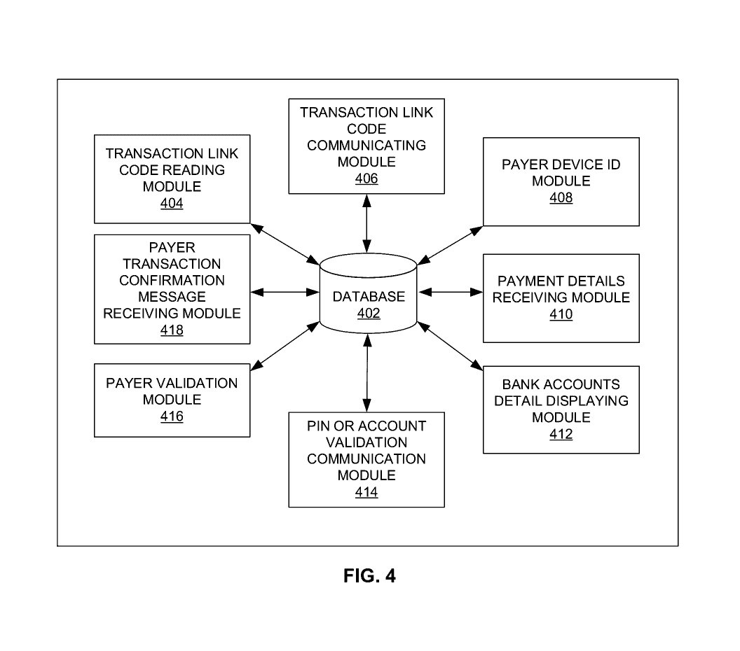

FIG. 4 illustrates an exploded view of a payer device 110 of FIG. 1 according to an embodiment herein. The payer device 110 includes a database 402, a transaction link code reading module 404, a transaction link code communicating module 406, a payer device id module 408, a payment details receiving module 410, a bank accounts detail displaying module 412, a pin or account validation communication module 414, a payer validation module 416, and a payer transaction confirmation message receiving module 418. The database 402 stores a device ID of the payer device 110, and one or more bank accounts details the payer 112 (e.g., Customer). The database 402 may or may not have an account number of the payee 102, and the payer 112. The transaction link code reading module 404 is configured to receive or read a transaction link code from the payee device 104. The transaction link code communicating module 406 is configured to communicate the transaction link code to the payment server 108. The payer device ID module 408 is configured to communicate a device ID of the payer device 110 along with the transaction link code to the payment server 108. The payment server 108 receives the transaction link code from the payer device 110 and identifies the device ID of the payer device 110. In one embodiment, the payment server 108 communicates with the directory service 114 to obtain the one or more bank accounts for the device ID of the payer device 110. The payment details receiving module 410 is configured to receive the payment details (i.e. payment amount) from the payment server 108 to make the payment transaction. The bank accounts detail displaying module 412 is configured to provide the one or more bank accounts to the payer 112 to select a bank account to make the payment transaction. In one embodiment, the payer 112 selects a bank account (e.g., credit card, debit card or other payments accounts) and enters the corresponding PIN number. The PIN or account validation communication module 414 is configured to communicate an encrypted PIN of the selected bank account to the payment server 108. In one embodiment, the payment server 108 authorizes the payment transaction by confirming the payment amount (that is billed at the payee device 104) available in the selected bank account of the payer 112. In another embodiment, the payment server 108 communicates with the payer bank server 116 to receive the payment amount that is approved by the payer 112 using the payer device 110. In yet another embodiment, the payer 112 confirms the payment transaction by a 2-factor, or a 3-factor authentication method, and the payment is transacted through the payment server 108. The payer validation module 416 is configured to validate the payer 112 when the payer 112 provides at least one of (i) an encrypted PIN of the selected bank account, and (b) a biometric parameter of the payer 112. In one embodiment, the biometric or 3 Factor

Authentication is finger print, voice recognition, and facial recognition. The payer transaction confirmation message receiving module 418 is configured to receive a confirmation message from the payment server 108 on receipt of the payment amount approved by the payer 112 from the payer bank server 116. In one embodiment, the payment server 108 communicates with the payee bank server 118 to transfer the payment amount that is billed at the payee device 104 for the payer 112.

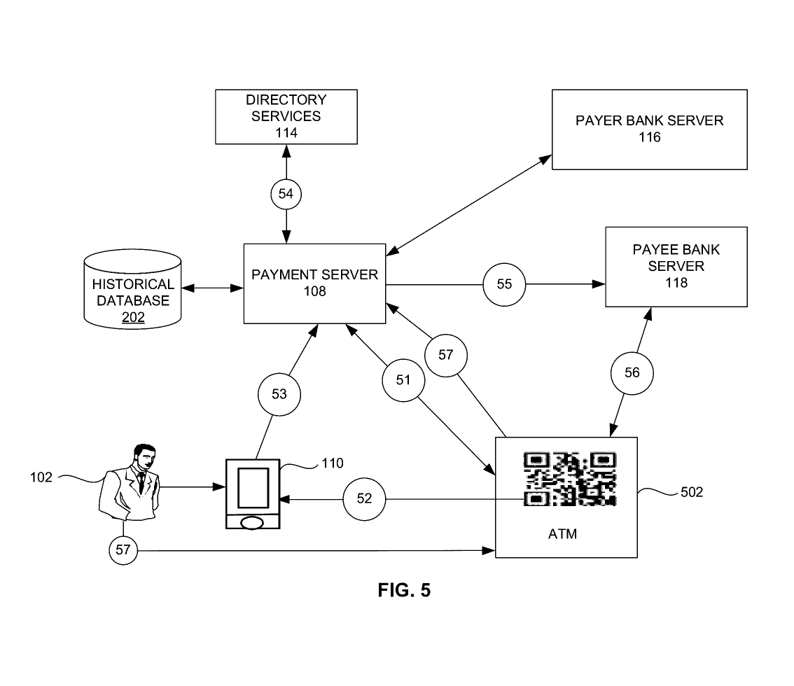

FIG. 5 illustrates an exemplary view of an Automated Teller Machine (ATM) 502 interacting with a payee 102 through a payment server 108 to perform a payment transaction according to an embodiment herein. At step 51, the ATM 502 communicates an activation request to the payment server 108 for an ATM link-code (i.e. a transaction link code). The activation request is accompanied by the ATM device ID/account ID. The payment server 108 generates a transaction link code and transmits the generated transaction link code to the ATM 502. In one embodiment, the ATM 502 is the dispenser/payer device 112. The payment server 108 establishes the ATM 502 and a payee bank server 118 through the directory service 114 and generates a transaction number for the transaction. In one embodiment, the directory service 114 includes (i) a bank name, (ii) a branch name of the payee 102 bank, (iii) the payee 102 contact number/device ID, (iv) name of payee, (v) mobile number, (vi) the ATM 502 device ID etc. At step 52, the ATM 502 receives the transaction link code from the payment server 108 and displays the transaction link code to the payee 102 via the ATM 502 terminal. In one embodiment, the transaction link code may be transmitted to the customer (i.e. the payer 112) via a QR code, or a Near field communication (NFC) code. The payee 102 selects a bank account (e.g., credit card, debit card or other payments accounts) on the payee device 110 to make a transaction. At step 53, the payee device 110 communicates (i) the transaction link code, (ii) the bank account of the payee 102, and (iii) details of the payee device ID/Account ID to the payment server 108. At step 54, the payment server 108 communicates with the directory service 114 to identify the ATM 502 and the payee 102. At step 55, the payment server 108 prompts the payee bank server 118 to request for the PIN number at the ATM 502. At step 56, the payment server 108 receives one or more bank accounts and a mobile number of the payee 102 from the directory service 114 and requests the payee 102 to enter the PIN number at the ATM 502 in a 2-factor authentication. In one embodiment, the payment server 108 requests the payee 102 to enter the PIN number on the ATM 502 in a 3 factor authentication as biometrics. At step 57, the encrypted PIN number is send to the payment server 108 to verify with a payer/issuer bank server 116 and unlocks the ATM 502 for a transaction when the PIN number is correct. The payments server 108 allows the payee 102 to make the transaction and communicates a confirmation message to the payee device 110, and the ATM 502 on receipt of the payment amount. In one embodiment, the payment server 108 communicates the transaction details such as accounts involved in transaction, the transaction number to identify the particular transaction, time and date of transaction, amounts of transaction, and banks involved in the transaction to the historical database 202.

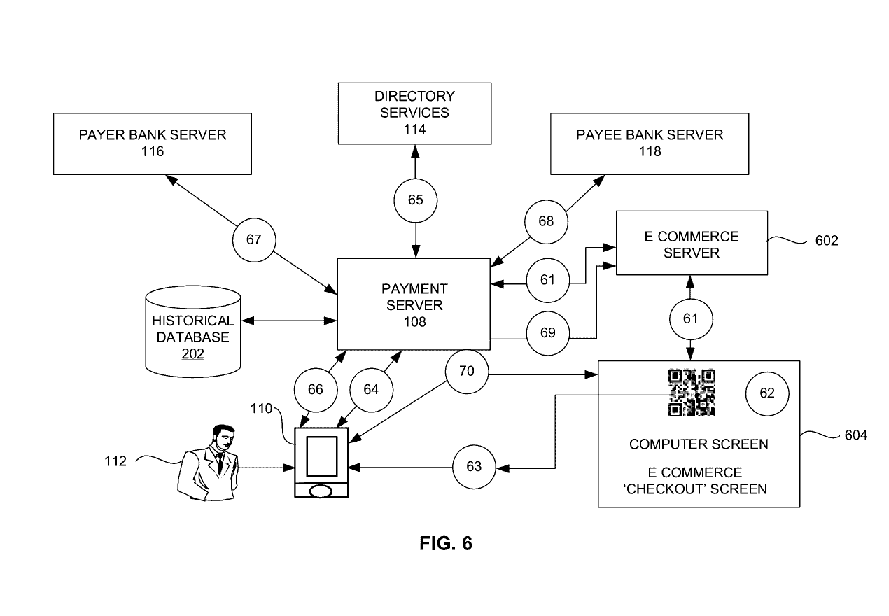

FIG. 6 illustrates an exemplary view of an E-commerce server 602 interacting with a payer 112 through a payment server 108 to perform a payment transaction according to an embodiment herein. At step 61, an E-commerce website communicates a request to the payment server 108 to initiate a payment transaction through the E-commerce server 602. The E-commerce website requests the payment server 108 along with the transaction details and account ID to initiate a payment transaction. In one embodiment, the E-commerce account is the payee 102. The payment server 108 communicates a transaction link code to the E-commerce website and generates a transaction number for the each transaction. At step 62, the transaction link code is displayed in an E-commerce checkout screen 604. In one embodiment, the transaction link code is displayed as a QR code. In another embodiment, the transaction link code includes billing amount details. At step 63, the payer 112 reads the transaction link code through the payer device 110. At step 64, the payer device 110 communicates the transaction link code to the payment server 108 along with the payer 112 device ID, and a billing address (i.e. bank account of the payer 112). In one embodiment, the payer device ID may be a mobile number. In one embodiment, the payer device 110 communication to the payment server 108 is encrypted. At step 65, the payment server 108 communicates with the directory service 114 to identify the payer 112 using the payer 112 device IDs. At step 66, the payment server 108 communicates the payment details (i.e. payment amount) to the payer device 110 for making payment transaction. The payer device 110 provides details of the bank account to the payer 112 to make the payment transaction. The payer 112 selects a bank account (e.g., credit card, debit card or other payments accounts) and enters the corresponding PIN number. The PIN number is entered in a 2-factor authentication and/or a 3-factor authentication as biometrics. At step 67, the payment server 108 authorizes the payment transaction by confirming the payment amount (that is billed at the payee device 104) available in the selected bank account of the payer 112. In one embodiment, the payment server 108 communicates with the payer bank server 116 to confirm the payment amount (that is billed at the payee device 104) available in the bank account of the payer 112. The payment server 108 initiates the transaction by receiving the payment amount from the payer bank server 116. At step 68, the payment server 108 communicates the acquirer bank server/payee bank server 118 to credit the payment amount to the E-commerce bank account. At step 69, the payment server 108 transmits a transaction link code to the E-commerce server 602 to inform the successful transaction. In one embodiment, the payment server 108 transmits non account details of the payer 112 such as billing address and or delivery address to the E-commerce server 602. At step 70, the payment server 108 communicates a confirmation message to the payer device 110, and the E-commerce checkout screen 604 on receipt of the payment amount. In one embodiment, once the receipt is received from the payment server 108 on the payment transaction, the E-commerce company ships the goods to the relevant payer 112. In another embodiment, the payment server 108 communicates the transaction details such as accounts involved in transaction, the transaction number to identify the particular transaction, time and date of transaction, amounts of transaction, and banks involved in the transaction to the historical database 202. In one embodiment, the E-commerce server 602 is directly communicates with the payer 112 through the payment server 108 to make the payment transaction. In another embodiment, the E-commerce server 602 eliminates the payer 112 need to login in details to an E-commerce website to make the payment transaction.

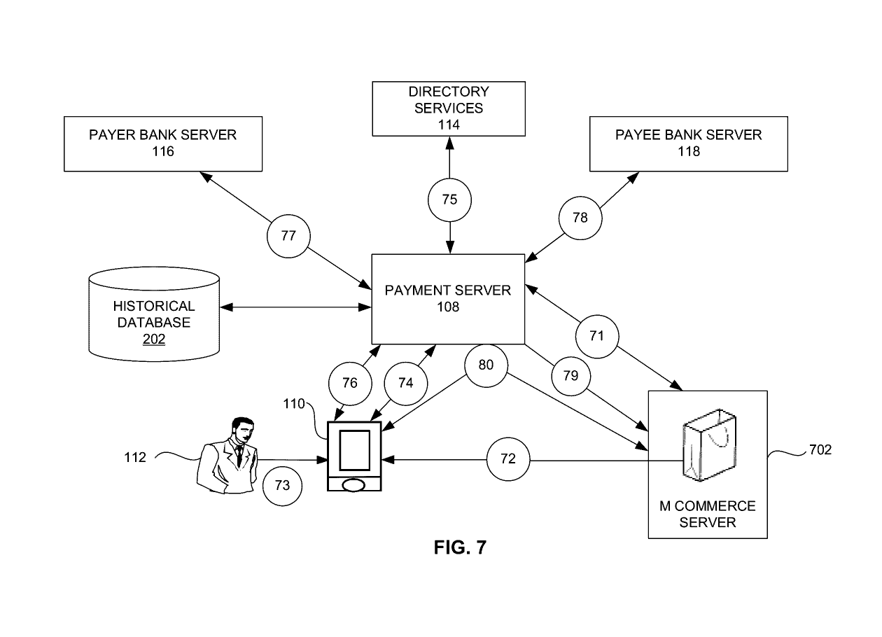

FIG. 7 illustrates an exemplary view of an M-commerce server 702 interacting with a payer 112 through a payment server 108 to perform a payment transaction according to an embodiment herein. At step 71, the M-commerce server 702 communicates a request to the payment server 108 to initiates a payment transaction when the payer 112 proceeds to check out. The M-commerce server 702 requests the payment server 108 along with the payment amount and an account ID to initiate a payment transaction. In one embodiment, the M-commerce account is a payee. The payment server 108 communicates a transaction link code to the M-commerce server 702 and generates a transaction number for the each transaction. In one embodiment, the transaction number is tagged to the transaction link code and stored into the historical database 202 for reference. At step 72, the transaction link code is transferred to the payment application on the payer device 110 from the M-commerce checkout on the payer device 110 to be sent back to the payment server 108. At step 73, the payment application reads the transaction link code through the payer device 110. In one embodiment, the payer 112 reads the transaction link code through the payer device 110. At step 74, the payer device 110 communicates the transaction link code to the payment server 108 along with the payer 112 contact numbers, and a billing address (i.e. bank account of the payer 112), and a device ID. In one embodiment, the payer device 110 communicates the transaction link code to the payment server 108 in encrypted form. At step 75, the payment server 108 communicates with the directory service 114 to identify the payer 112 using the payer 112 device ID. In one embodiment, the device ID may be a phone number. At step 76, the payment server 108 communicates the payment amount to the payer device 110 for making payment. The payer device 110 provides the one or more bank account to the payer 112 to make the payment transaction. The payer 112 selects a bank account (e.g., credit card, debit card or other payments accounts) and enters the corresponding PIN number. The PIN number is entered in a 2-factor authentication and/or a 3-factor authentication using biometrics. At step 77, the payment server 108 authorizes the payment transaction by confirming the payment amount available in the selected bank account of the payer 112. In one embodiment, the payment server 108 communicates with a payer bank server 116 to confirm the payment amount available in the selected bank account of the payer 112. The payment server 108 initiates the transaction by receiving the payment amount from the payer bank server 116. At step 78, the payment server 108 communicates the acquirer bank server/payee bank server 118 to credit the payment amount to the M-commerce bank account. At step 79, the payment server 108 communicates a Transaction number to the M-commerce server 702 to inform the successful transaction. In one embodiment, the payment server 108 communicates non account details of the payer 112 such as billing address and or delivery address to the

M-commerce server 702. At step 80, the payment server 108 communicates a confirmation message to the payer device 110, and the M-commerce server 702 on receipt of the payment amount. In one embodiment, once the receipt is received from the payment server 108 on the payment transaction, the M-commerce company ships the goods to the relevant payer 112. In another embodiment, the payment server 108 communicates the transaction details such as accounts involved in transaction, the transaction number to identify the particular transaction, time and date of transaction, amounts of transaction, and banks involved in the transaction to the historical database 202.

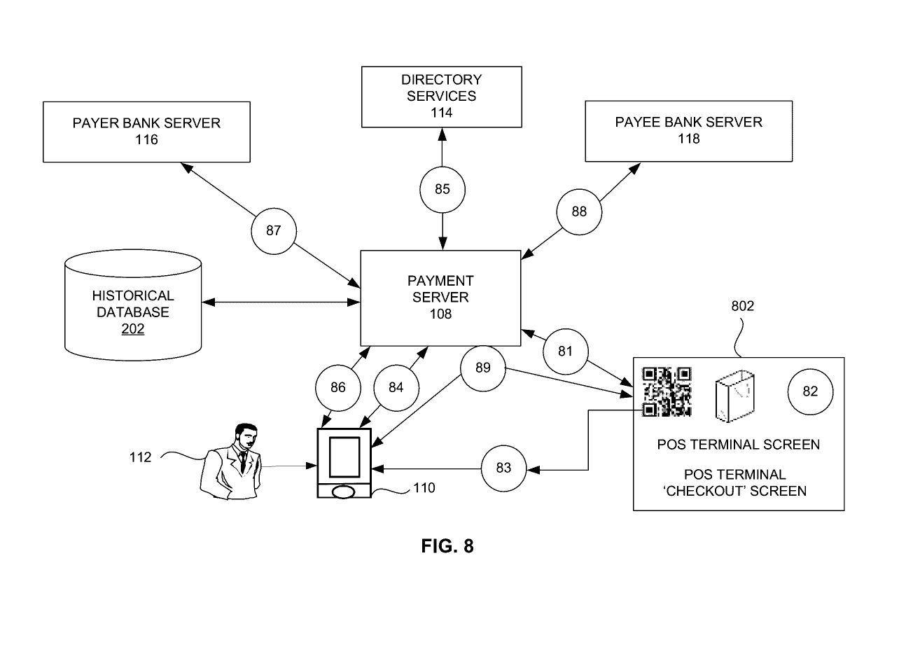

FIG. 8 illustrates an exemplary view of a Point of Sale (POS) terminal 802 interacting with a payer 112 through a payment server 108 to perform a payment transaction according to an embodiment herein. At step 81, the POS terminal 802 communicates a request to the payment server 108 to initiates a payment transaction. The POS terminal 802 requests the payment server 108 along with the payment amount, and account ID to initiate a payment transaction. In one embodiment, the merchant account is the payee 102. The payment server 108 communicates a transaction link code to the POS terminal 802 and generates a transaction number for the each transaction. At step 82, the transaction link code is displayed in the payer device 110 and a POS terminal checkout screen. In one embodiment, the transaction link code is displayed as a QR code and/or a Near field communication (NFC) code. In another embodiment, the transaction link code includes billing amount. At step 83, the payer 112 reads the transaction link code through the payer device 110. At step 84, the payer device 110 communicates the transaction link code to the payment server 108 along with the payer 112 phone numbers (i.e. device ID), and a billing address (i.e. bank account of the payer 112). In one embodiment, the payer device 110 communicates the transaction link code to the payment server 108 in encrypted form. At step 85, the payment server 108 communicates with the directory service 114 to identify the payer 112 using the payer 112 phone number (i.e. device ID). At step 86, the payment server 108 communicates the payment amount to the payer device 110 for making payment. The payer device 110 provides the one or more bank account to the payer 112 to make the payment transaction. The payer 112 selects a bank account (e.g., credit card, debit card or other payments accounts) and enters the corresponding PIN number. The PIN number is entered in a 2-factor authentication and/or a 3-factor authentication using biometrics. At step 87, the payment server 108 authorizes the payment transaction by confirming the payment amount available in the selected bank account of the payer 112. In one embodiment, the payment server 108 communicates with the payer bank server 116 to confirm the payment amount available in the bank account of the payer 112. The payment server 108 initiates the transaction by receiving the payment amount from the payer bank server 116. At step 88, the payment server 108 communicates the merchant bank server/payee bank server 118 to credit the payment amount to the payee 102 bank account. The payment server 108 communicates a Transaction number to the POS terminal 802 to inform the successful transaction. At step 89, the payment server 108 communicates a confirmation message to the payer device 110, and the POS terminal 802 on receipt of the payment amount. The payer 112 receives the goods and leaves the store or market place with a receipt on the payer device 110. In another embodiment, the payment server 108 communicates the transaction details such as accounts involved in transaction, the transaction number to identify the particular transaction, time and date of transaction, amounts of transaction, and banks involved in the transaction to the historical database 202.

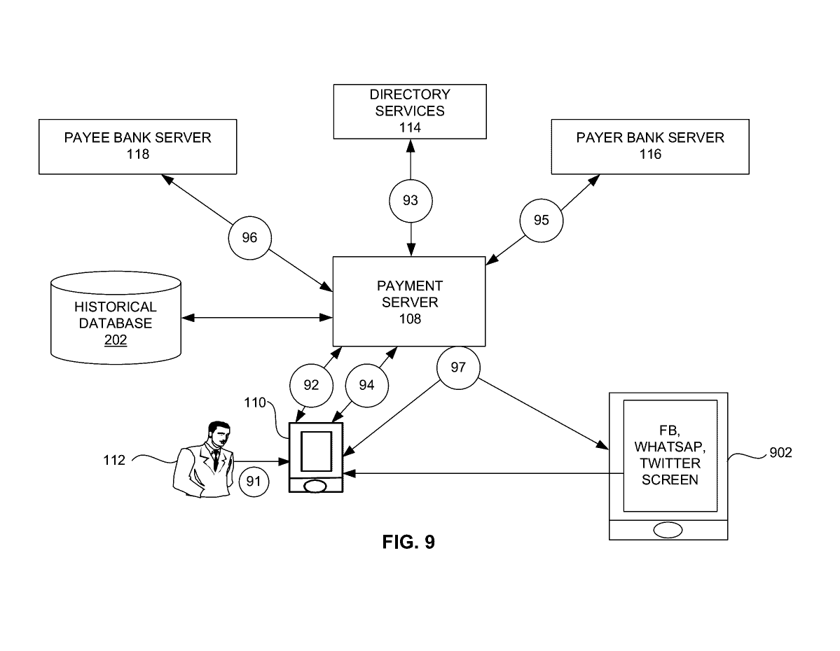

FIG. 9 illustrates an exemplary view of a social networking website 902 interacting with a payer 112 through a payment server 108 to perform a payment transaction according to an embodiment herein. At step 91, the payer 112 communicates a payment transaction request to the payment server 108 from the social networking website 902 with particular markers. In one embodiment, the social networking website 902 may be face book, twitter, whatsapp, and etc. At step 92, the payer 112 communicates details of the payee 102 or one or more payees, and payment amount to the payment server 108. In one embodiment, the payee 102, or the one or more payees have an account for the transaction. If the transaction is failed, the payment amount is credited to a payment server account of the particular payee 102. The payment server 108 transfers the payment amount to the payee 102 bank account from the payment server account when the requisite credentials are suitably presented. In one embodiment, the payment server 108 generates a transaction number for each transaction. The payment server 108 picks the markers for the transaction and identifies the payer 112, and the payee 102. At step 93, the payment server 108 communicates with the directory service 114 to identify the payer 112 using the payer 112 phone number, or other relevant IDs. In one embodiment, the directory service 114 includes a bank name, branch name of the payee 102 bank, the payee 102 phone number, etc. At step 94, the payment server 108 prompts the payer 112 to select a bank account (e.g., credit card, debit card or other payments accounts) and enters the corresponding PIN number. In one embodiment, the payment server 108 prompts the payer 112 to login the face book or twitter account to identify the payer 112. In one embodiment, the payment server 108 authorizes the payment transaction by confirming the payment amount available in the selected bank account of the payer 112. At step 95, the payment server 108 communicates with the payer bank server 116 to receive the payment amount. At step 96, the payment server 108 communicates the payee bank server 118 to credit the payment amount. At step 97, the payment server 108 communicates a confirmation message to the payer device 110, and the payee device 102 on receipt of the payment amount. In one embodiment, the payment server 108 communicates the transaction details such as accounts involved in transaction, the transaction number to identify the particular transaction, time and date of transaction, amounts of transaction, and banks involved in the transaction to the historical database 202.

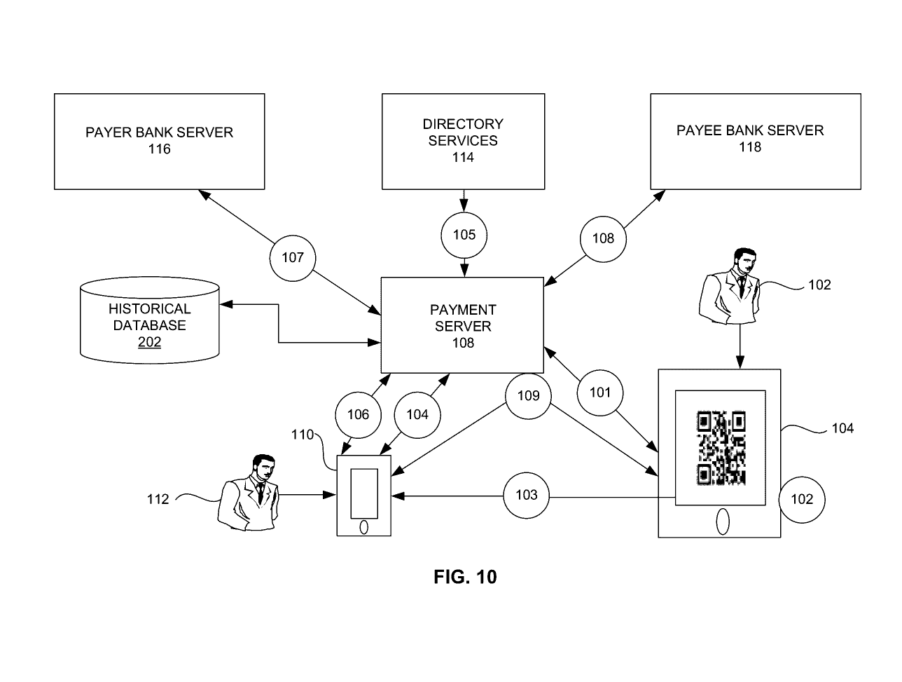

FIG. 10 illustrates an exemplary view of a peer to peer present (P2P) transaction according to an embodiment herein. At step 101, the payee 102 requests the payment server 108 for a transaction link code to initiates a payment transaction using the payee device 104. The payment server 108 prompts the payee 102 for payment details (i.e. payment amount) and the relevant account to the payment amount to credit. The payee 102 communicates the payment amount and the relevant account details to the payment server 108 through the payee device 104. The payee 102 in the transaction is established by referencing the directory service 114. The payment server 108 generates a transaction code for the each transaction. In one embodiment, the payment server 108 communicates the transaction link code to the payee device 104. At step 102, the payee device 104 displays the transaction link code and transmits the transaction link code to the payer device 110. In one embodiment, the transaction link code e is displayed as a QR code or NFC. At step 103, the payer 112 receives the transaction link code from the payee device 104 and reads the transaction link code through the payer device 110. At step 104, the payer device 110 communicates the transaction link code to the payment server 108 along with the payer 112 phone number (i.e. device ID). In one embodiment, the payer device 110 communicates the transaction link code to the payment server 108 in encrypted form. At step 105, the payment server 108 communicates with the directory service 114 to identify the payer 112 using the phone number (i.e. device ID) of the payer 112 or relevant IDs. The payer device 110 provides one or more bank accounts to the payer 112 to make the payment. At step 106, the payer 112 selects a bank account (e.g., credit card, debit card or other payments accounts) and enters the corresponding PIN number. The PIN number is entered in a 2-factor authentication and/or a 3-factor authentication using biometrics. At step 107, the payment server 108 receives the payment amount from the payer bank server 116 after verification. At step 108, the payment server 108 communicates the payee bank server 118 to credit the payment amount to the payee bank account. At step 109, the payment server 108 communicates a confirmation message to the payer device 110, and the payee device 104 on receipt of the payment amount. In one embodiment, the payment server 108 communicates the transaction details such as accounts involved in transaction, the transaction number to identify the particular transaction, time and date of transaction, amounts of transaction, and banks involved in the transaction to the historical database 202.

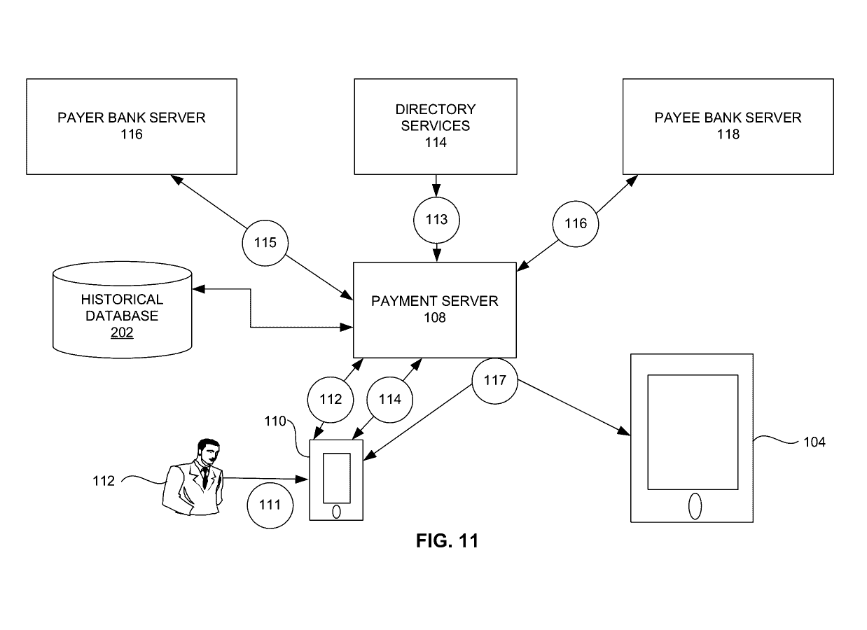

FIG. 11 illustrates an exemplary view of a mobile to mobile transaction according to an embodiment herein. At step 111, the payer 112 initiates a payment transaction by selecting the payee 102 phone number and specifying the amount to be transferred. The payee 102 and the payer 112 have the default accounts in the payment server 108 for the payment transaction. If the transaction is failed, the payment amount is credited to a payment server account. The payment server 108 transfers the payment amount to a payee account from the payment server account when the requisite credentials are suitably presented. At step 112, the details of the payee 102, the payer 112 phone numbers (i.e. the payer 112 device ID, and the payee 104 device ID), and the payment amount is communicated with the payment server 108. At step 113, the payment server 108 receives the details of the payee 102, and the payer 112 from the directory service 114 for the transaction and identifies the payer 112, and the payee 102. In one embodiment, the payment server 108 includes (i) a bank name, (ii) branch name of the payee 102 bank, (iii) the payee 102 phone number, and etc. At step 114, the payment server 108 prompts the payer 112 to select a bank account (e.g., credit card, debit card or other payments accounts) and enters the corresponding PIN number. The PIN number is entered in a 2-factor authentication and/or a 3-factor authentication using biometrics. At step 115, the payment server 108 authorizes the payment transaction by confirming the payment amount (that is billed at the payee device 104) available in the selected bank account of the payer 112. The payment server 108 initiates the transaction by receiving the payment amount from the payer bank server 116. At step 116, the payment server 108 communicates the payee bank server 118 to credit the payment amount to the payee bank account. At step 117, the payment server 108 communicates a confirmation message to the payer device 110, and the payee device 104 on receipt of the payment amount. In one embodiment, the payment server 108 communicates the transaction details such as accounts involved in transaction, the transaction number to identify the particular transaction, time and date of transaction, amounts of transaction, and banks involved in the transaction to the historical database 202.

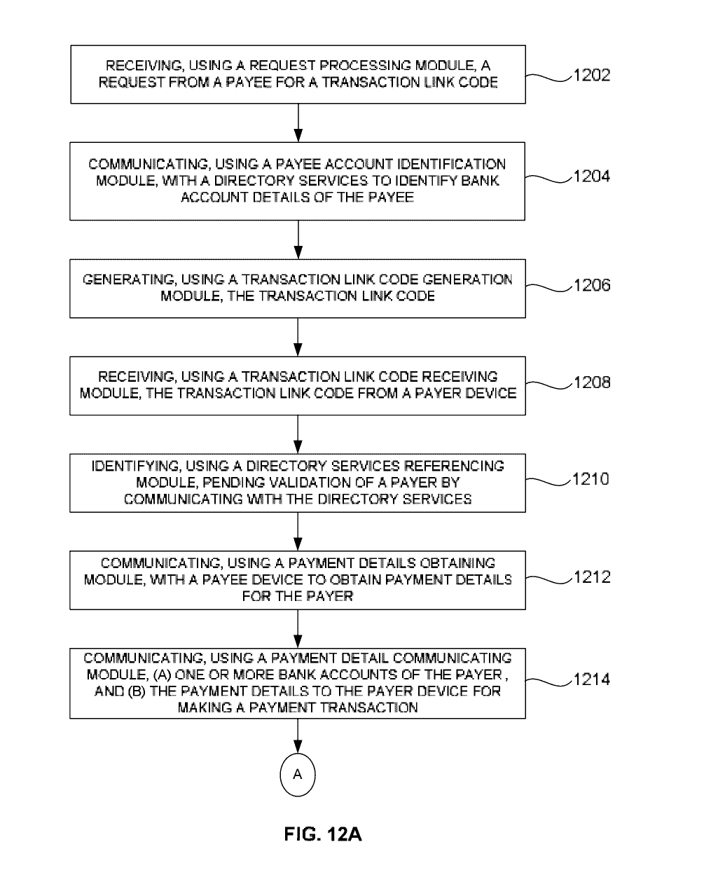

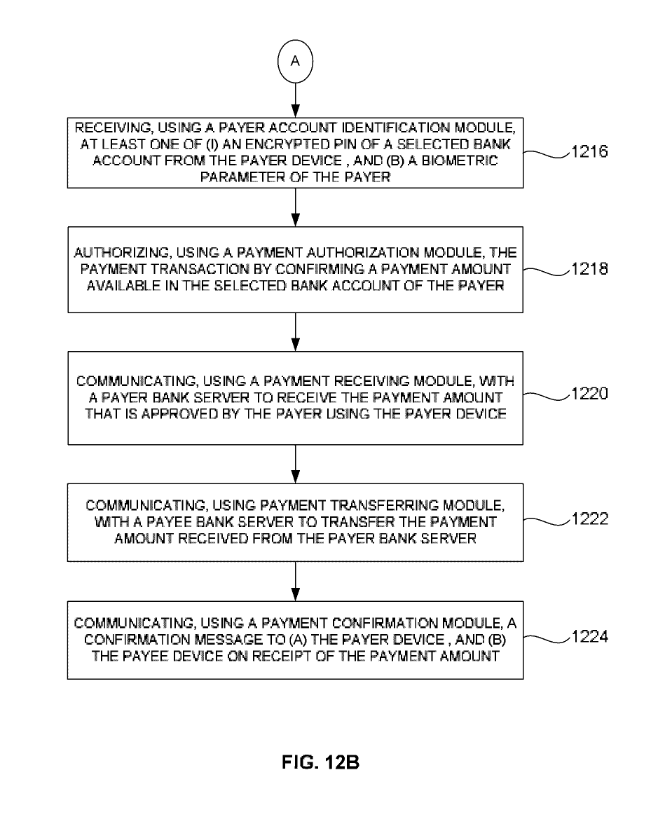

FIGS. 12A and 12B are flow diagrams illustrating a method of communication between a payee device 104 and a payer device 110 through a payment server 108 of FIG. 1 according to an embodiment herein. At step 1202, the payment server 108 receives the payment request from the payee device 104 to initiate a payment transaction. The payee device 104 communicates the payment request along with the device ID/account ID. At step 1204, the payment server 108 communicates with the directory service 114 and establishes the identification of the payee 102 using device ID. At step 1206, the payment server 108 generates the transaction link code and communicates the transaction link code to the payee device 104. At step 1208, the payment server 108 receives the transaction link code from the payer device 110 along with the device ID/account ID of the payer device 110. At step 1210, the payment server 108 establishes the identification of the payer 112 pending validation, by communicating with the directory service 114. In one embodiment, the payment server 108 establishes the communication with the payee device 104, and the payer device 110 independent of each other. In another embodiment, the device ID/account ID may be a phone number and machine fingerprint of the payee device 104, or the payer device 110. In yet another embodiment, the device ID/account ID of the payee 102 and the payer 112 may be stored in the directory service 114. In yet another embodiment, the device ID/account ID of the payee 102 and the payer 112 are maintained by the payment server 108. At step 1212, the payment server 108 communicates with the payee device 104 to obtain payment details (i.e. payment amount) for the payer 112. At step 1214, the payment server 108 communicates (a) the one or more bank accounts of the payer 112, and (b) the payment details (i.e. payment amount) to the payer device 110 for making the payment transaction. In one embodiment, the payer device 110 provides details of the one or more bank accounts to the payer 112 to make the payment. In another embodiment, the payer 112 selects a bank account (e.g., credit card, debit card or other payments accounts) and enters the corresponding PIN number. At step 1216, the payment server 108 receives (i) an encrypted PIN of the selected bank account from the payer device 110, and (b) a biometric parameter of the payer 112. At step 1218, the payment server 108 authorizes the payment transaction by confirming the payment amount (that is billed at the payee device 104) is available in the selected bank account of the payer 112. At step 1220, the payment server 108 communicates with the payer bank server 116 to block/receive the payment amount that is approved by the payer 112 using the payer device 110. In one embodiment, the payer 112 confirms the payment transaction by a 2-factor, or a 3-factor authentication method, and the payment is transacted through the payment server 108. At step 1222, the payment server 108 communicates with the payee bank server 118 to transfer the payment amount to the payee bank server 118. At step 1224, the payment server 108 communicates a confirmation message to (a) the payer device, and (b) the payee device on receipt of the payment amount.

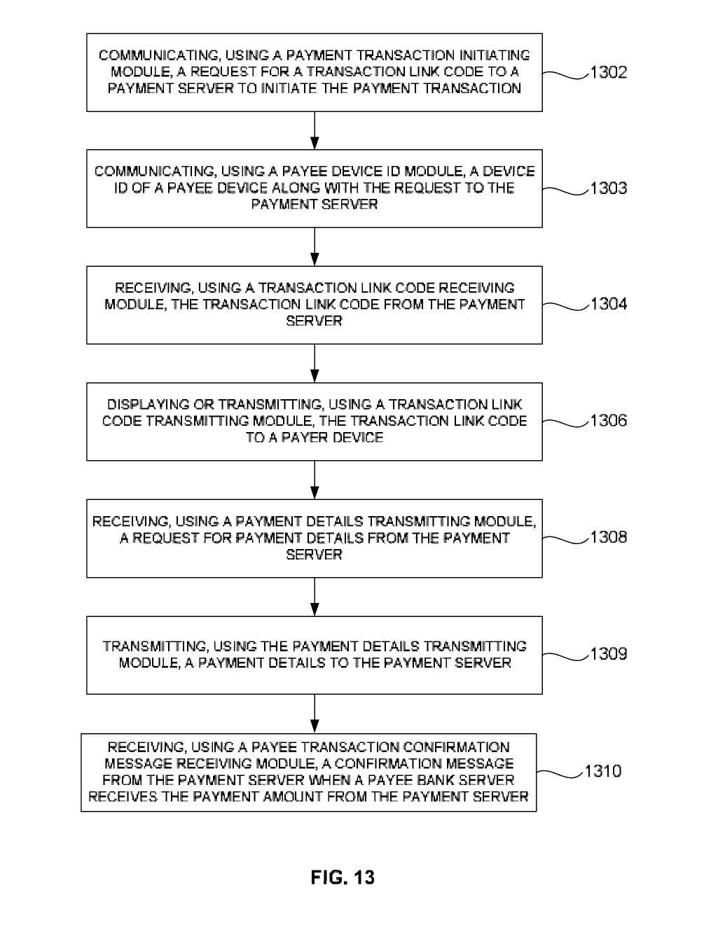

FIG. 13 is a flow diagram illustrating a method of a payee device 104 communicates with a payment server 108 and a payer device 110 of FIG. 1 according to an embodiment herein. At step 1302, the payee 102 communicates the request for the transaction link code to the payment server 108 to initiate the payment transaction using the payee device 104. At step 1303, the payee device 104 communicates the device ID of the payee device 104 along with the request to the payment server 108. At step 1304, the payee device 104 receives the transaction link code from the payment server 108. At step 1306, the payee device 104 receives the transaction link code from the payment server 108 and displays or transmits the transaction link code to the payer device 110. In one embodiment, the payee device 104 displays the received transaction link code to the payee 102. At step 1308, the payee device 104 receives the request for payment details from the payment server 108. At step 1309, the payee device 104 transmits the payment details (i.e. payment amount) to the payment server 108. In one embodiment, the payee 102 communicates the payment details to the payment server 108 through the payee device 104. At step 1310, the payee device 104 receives a confirmation message from the payment server 108 when the payee bank server 118 receives the payment amount from the payment server 108.

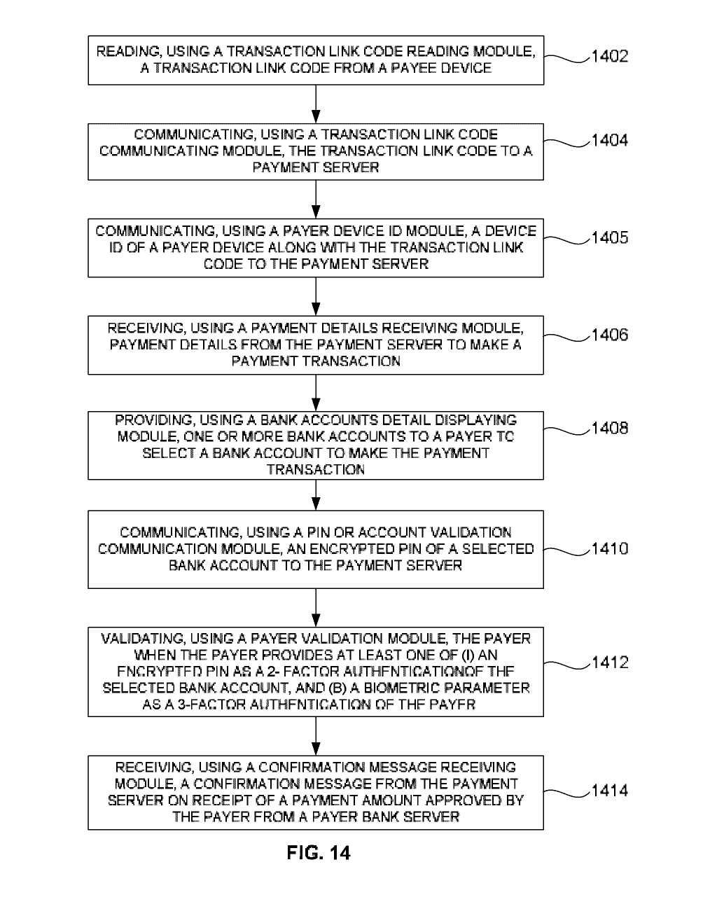

FIG. 14 is a flow diagram illustrating a method of a payer device 110 communicates with a payment server 108 and a payee device 104 of FIG. 1 according to an embodiment herein. At step 1402, the payer 112 reads the transaction link code from the payee device 104. At step 1404, the payer device 110 communicates the transaction link code to the payment server 108. At step 1405, the payer device 110 communicates the device ID of the payee device 104 along with the transaction link code to the payment server 108. At step 1406, the payer device 110 receives the payment details (i.e. payment amount) from the payment server 108 to make the payment transaction. At step 1408, the payer device 110 provides the one or more bank accounts to the payer 112 to select a bank account to make the payment transaction. At step 1410, the payer device 110 communicates an encrypted PIN of the selected bank account of the payer 112 to the payment server 108. The payer 112 confirms the payment transaction by a 2-factor, or a 3-factor authentication method, and the payment is transacted through the payment server 108. At step 1412, the payer device 110 validates the payer 112 when the payer 112 provides at least one of (i) an encrypted PIN of the selected bank account, and (b) a biometric parameter of the payer 112. In one embodiment, the 2-factor authentication is a PIN number for the respective accounts, or one time password. In another embodiment, the biometric or 3 Factor Authentication is finger print, voice recognition, and facial recognition. At step 1414, the payer device 110 receives a confirmation message from the payment server 108 on receipt of the payment amount approved by the payer 112 from the payer bank server 116.

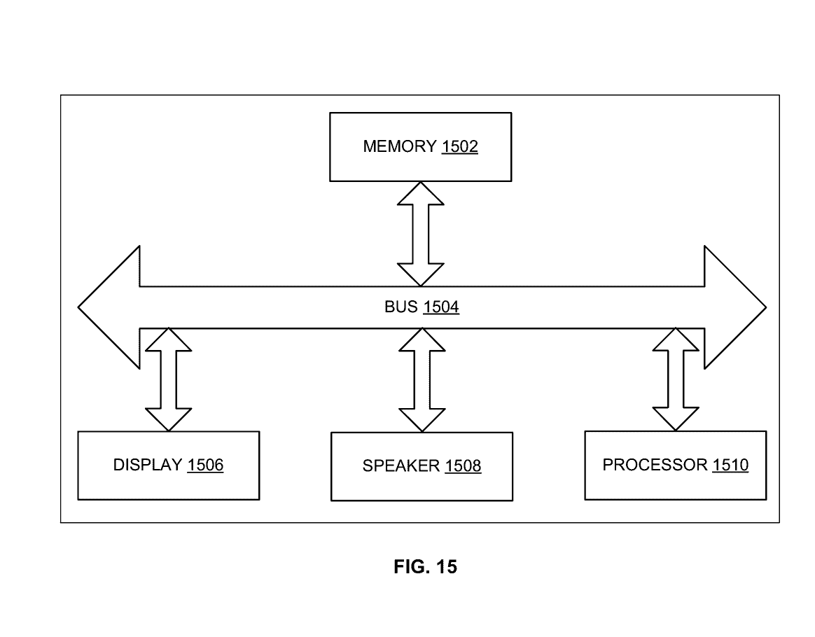

FIG. 15 illustrates an exploded view of the personal communication device having an a memory 1502 having a set of computer instructions, a bus 1504, a display 1506, a speaker 1508, and a processor 1510 capable of processing a set of instructions to perform any one or more of the methodologies herein, according to an embodiment herein. In one embodiment, the receiver may be the personal communication device. The processor 1510 may also enable digital content to be consumed in the form of video for output via one or more displays 1506 or audio for output via speaker and/or earphones 1508. The processor 1510 may also carry out the methods described herein and in accordance with the embodiments herein.

Digital content may also be stored in the memory 1502 for future processing or consumption. The memory 1502 may also store program specific information and/or service information (PSI/SI), including information about digital content (e.g., the detected information bits) available in the future or stored from the past. A user of the personal communication device may view this stored information on display 1506 and select an item of for viewing, listening, or other uses via input, which may take the form of keypad, scroll, or other input device(s) or combinations thereof. When digital content is selected, the processor 1510 may pass information. The content and PSI/SI may be passed among functions within the personal communication device using the bus 1504.

The techniques provided by the embodiments herein may be implemented on an integrated circuit chip (not shown). The chip design is created in a graphical computer programming language, and stored in a computer storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly.

The stored design is then converted into the appropriate format (e.g., GDSII) for the fabrication of photolithographic masks, which typically include multiple copies of the chip design in question that are to be formed on a wafer. The photolithographic masks are utilized to define areas of the wafer (and/or the layers thereon) to be etched or otherwise processed.

The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections). In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

The embodiments herein can take the form of, an entirely hardware embodiment, an entirely software embodiment or an embodiment including both hardware and software elements. The embodiments that are implemented in software include but are not limited to, firmware, resident software, microcode, etc. Furthermore, the embodiments herein can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, remote controls, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

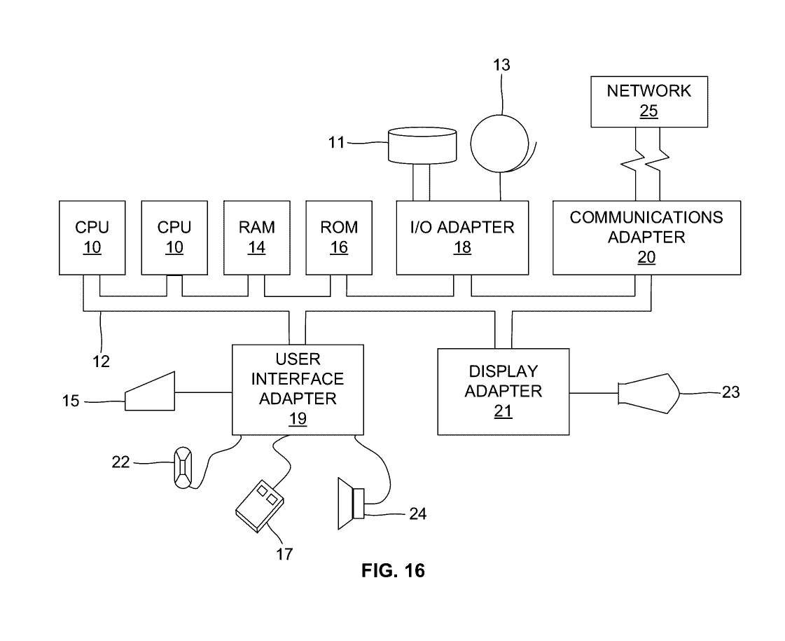

A representative hardware environment for practicing the embodiments herein is depicted in FIG. 16. This schematic drawing illustrates a hardware configuration of an information handling/computer system in accordance with the embodiments herein. The system comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments herein.

The system further includes a user interface adapter 19 that connects a keyboard 15, mouse 17, speaker 24, microphone 22, and/or other user interface devices such as a touch screen device (not shown) or a remote control to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The communication between the payee 102 and the payer 112 is established by the payment server 108 and no sensitive communication happens between the payer 112 and the payee 102 directly. The payment server 108 communicates with the payee 102 and the payer 112 separately to perform the transaction. The transaction link code includes transactional details such as payment amount, details about payee 102, and details about the payer 112 so the transaction link code reduces the number of steps to make the payment transaction. The payment transaction is more confidential when using transaction link code. No need to disclose the account details to payee 102. The transaction link code payment system is a universal system across everything from the ATM 502 to mobile payments to the peer to peer present transaction. The entire payment transaction is done in cloud. The payee 102 provides the loyalty service to the payer 112 using the transaction link code based payment transaction. The account information may not be stored in the payee device 104, or the payer device 110. No need for E-commerce account (i.e. separate account to access E-commerce website) to done the payment transaction in the transaction link code payment system.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A payment server for authenticating a transaction between a payer device and a payee device, said payment server comprising:
(i) a memory unit that stores (a) a set of modules, and (b) a historical database; and
(ii) a processor which executes said set of modules, wherein said set of modules comprise:
a request processing module, executed by said processor, configured to receive a request from a payee for a transaction link code;
a payee account identification module, executed by said processor, configured to communicate with a directory service to identify bank account details of said payee;
a transaction link code generation module, executed by said processor, configured to generate said transaction link code, wherein said transaction link code generation module communicates said transaction link code to said payee device;
a transaction link code receiving module, executed by said processor, configured to receive said transaction link code from said payer device,
a directory service referencing module, executed by said processor, configured to communicate with said directory service to identify (a) a bank account of said payee based on a device ID of said payee device, and (a) one or more bank accounts of a payer based on a device ID of said payer device;
a payment details obtaining module, executed by said processor, configured to communicate with said payee device to obtain payment details for said payer;
a payment details communicating module, executed by said processor, configured to communicate (a) said one or more bank accounts of said payer, and (b) said payment details to said payer device for making a payment transaction;
a payer account identification module, executed by said processor, configured to receive at least one of (i) an encrypted PIN of a selected bank account from said payer device, and (b) a biometric parameter of said payer;
a payment authorization module, executed by said processor, configured to authorize said payment transaction by confirming a payment amount available in said selected bank account of said payer;
a payment receiving module, executed by said processor, configured to communicate with a payer bank server to receive said payment amount that is approved by said payer using said payer device;
a payment transferring module, executed by said processor, configured to communicate with a payee bank server to transfer said payment amount received from said payer bank server; and
a payment confirmation module, executed by said processor, configured to communicate a confirmation message to (a) said payer device, and (b) said payee device on receipt of said payment amount.

2. The server as claimed in claim 1, wherein said directory service (i) stores identity information of said payee and said payer, (ii) establishes said payer and said payee comprises:
(i) a memory unit that stores (a) a set of modules, and (b) a historical database; and
(ii) a processor which executes said set of modules, wherein said set of modules comprise:
a bank accounts registration module, executed by said processor, configured to provide an option to (a) said payee bank server, and (b) said payer bank server to register with said directory service;
an account information obtaining module, executed by said processor, configured to obtain account information of (a) said payee from said payee bank server, and (b) said payer from said payer bank server;
a payee account information communication module, executed by said processor, configured to communicate said account information of said payee with said payment server when said payment server requests said directory service; and
a payer account information communication module, executed by said processor, configured to communicate said account information of said payer with said payment server when said payment server requests said directory service.

3. The server as claimed in claim 1, wherein said payee device comprises:
(i) a memory unit that stores (a) a set of modules, and (b) a database; and
(ii) a processor which executes said set of modules, wherein said set of modules comprise:
a payment transaction initiating module, executed by said processor, configured to communicate a request for said transaction link code to said payment server to initiate said payment transaction;
a payee device ID module, executed by said processor, configured to communicate said device ID of said payee device along with said request to said payment server;
a transaction link code receiving module, executed by said processor, configured to receive said transaction link code from said payment server;
a transaction link code transmitting module, executed by said processor, configured to display or transmit said transaction link code to said payer device;
a payment details transmitting module, executed by said processor, configured to (a) receive a request for payment details from said payment server, and (b) transmits said payment details to said payment server; and
a payee transaction confirmation message receiving module, executed by said processor, configured to receive a confirmation message from said payment server when said payee bank server receives said payment amount from said payment server.

4. The server as claimed in claim 1, wherein said payer device comprises:
(i) a memory unit that stores (a) a set of modules, and (b) a database; and
(ii) a processor which executes said set of modules, wherein said set of modules comprise:
a transaction link code reading module, executed by said processor, configured to receive or read said transaction link code from said payee device;
a transaction link code communicating module, executed by said processor, configured to communicate said transaction link code to said payment server;
a payer device ID module, executed by said processor, configured to communicate said device ID of said payer device along with said transaction link code to said payment server;
a payment details receiving module, executed by said processor, configured to receive said payment details from said payment server to make said payment transaction;
a bank accounts detail displaying module, executed by said processor, configured to provide the one or more bank accounts to said payer to select a bank account to make said payment transaction;
a pin or account validation communication module, executed by said processor, configured to communicate an encrypted PIN of said selected bank account to said payment server;
a payer validation module, executed by said processor, configured to validate said payer when said payer provides at least one of (i) an encrypted PIN of said selected bank account, and (b) a biometric parameter of said payer; and
a payer transaction confirmation message receiving module, executed by said processor, configured to receive a confirmation message from said payment server on receipt of said payment amount approved by said payer from said payer bank server.

5. The server as claimed in claim 1, wherein said historical database of said payment server stores transaction data and transaction numbers which can be called upon by said payment sever in case of chargebacks and to resolve any disputes or enquiries, wherein said historical database keeps a record of all transactions for future reference by said payment server.

6. The server as claimed in claim 1, wherein said payment server provides said payee with payer information and purchase details so that said payee can tailor loyalty programs and perform marketing analytics on sales data and payer profiles.

7. The server as claimed in claim 2, wherein said directory service does not store account amount details of said payee, or said payer which enhances privacy, wherein said on a mobile phone, prevents hacking fraud.

8. The server as claimed in claim 4, wherein said payer is authorized by an encrypted PIN in a 2-factor authentication scenario, and a 3-factor authentication/said biometric parameter, wherein said 2-factor authentication is a PIN number, wherein said 3-factor authentication is a finger print, voice recognition, or facial recognition, wherein (i) a 1-factor in authentication is ‘something said payer has’ which is said payer mobile phone, (ii) said 2-factor authentication is ‘something said payer knows or carries in head’, and (iii) said 3-factor authentication may be ‘something that said payer is’ which is a biometric identification.

9. The server as claimed in claim 1, wherein said payment server tags (i) said device ID of said payee device (ii) said device ID of said payer device, and (iii) account descriptions to said transaction link code to generate a transaction number for said payment transaction.

10. The server as claimed in claim 1, wherein said transaction link code may be a QR code, or a Near field communication (NFC) code.

11. The server as claimed in claim 1, wherein said payer device may be an ATM.

12. The server as claimed in claim 1, wherein said payer device communicates with at least one of: (i) an E-commerce server, (ii) an M-commerce server, (iii) a point of sale terminal, (iv) a social networking web site, and (v) another payer in a peer to peer present transaction of said payee device to perform said payment transaction.

13. The server as claimed in claim 1, wherein said payment server provides an e-receipt to said payer device with details of entire transaction to track a budget of said payer.

14. The server as claimed in claim 12, wherein said E-commerce and M-commerce servers directly accesses said payer details such as shipping address from said payment commerce server eliminates said payer to login to an E-commerce web site to make said payment transaction.

15. A universal payment system for authenticating a transaction between a payer and a payee without sharing account identification information of a payer to a payee or vice versa, wherein said universal payment system comprises a payment server, a payee device, and a payer device, said payment server comprising:
(i) a memory unit that stores (a) a set of modules, and (b) a historical database; and
(ii) a processor which executes said set of modules, wherein said set of modules comprise:
a request processing module, executed by said processor, configured to receive a request from a payee for a transaction link code;
a payee account identification module, executed by said processor, configured to communicate with a directory service to identify bank account details of said payee;
a transaction link code generation module, executed by said processor, configured to generate said transaction link code, wherein said transaction link code generation module communicates said transaction link code to said payee device;
a transaction link code receiving module, executed by said processor, configured to receive said transaction link code from said payer device;
a directory service referencing module, executed by said processor, configured to communicate with said directory service to identify (a) a bank account of said payee based on a device ID of said payee device, and (a) one or more bank accounts of a payer based on a device ID of said payer device;
a payment details obtaining module, executed by said processor, configured to communicate with said payee device to obtain payment details for said payer;
a payment details communicating module, executed by said processor, configured to communicate (a) said one or more bank accounts of said payer, and (b) said payment details to said payer device for making a payment transaction;
a payer account identification module, executed by said processor, configured to receive at least one of (i) an encrypted PIN of a selected bank account from said payer device, and (b) a biometric parameter of said payer;
a payment authorization module, executed by said processor, configured to authorize said payment transaction by confirming a payment amount available in said selected bank account of said payer;
a payment receiving module, executed by said processor, configured to communicate with a payer bank server to receive said payment amount that is approved by said payer using said payer device;
a payment transferring module, executed by said processor, configured to communicate with a payee bank server to transfer said payment amount received from said payer bank server; and
a payment confirmation module, executed by said processor, configured to communicate a confirmation message to (a) said payer device, and (b) said payee device on receipt of said payment amount,
wherein said payee device comprises:
(i) a memory unit that stores (a) a set of modules, and (b) a database; and
(ii) a processor which executes said set of modules, wherein said set of modules comprise:
a payment transaction initiating module, executed by said processor, configured to communicate a request for said transaction link code to said payment server to initiate said payment transaction;
a payee device ID module, executed by said processor, configured to communicate said device ID of said payee device along with said request to said payment server;
a transaction link code receiving module, executed by said processor, configured to receive said transaction link code from said payment server;
a transaction link code transmitting module, executed by said processor, configured to display or transmit said transaction link code to said payer device;
a payment details transmitting module, executed by said processor, configured to (a) receive a request for payment details from said payment server, and (b) transmits said payment details to said payment server; and
a payee transaction confirmation message receiving module, executed by said processor, configured to receive a confirmation message from said payment server when said payee bank server receives said payment amount from said payment server,
wherein said payer device comprises: and
(i) a memory unit that stores (a) a set of modules, and (b) a database; and
(ii) a processor which executes said set of modules, wherein said set of modules comprise:
a transaction link code reading module, executed by said processor, configured to receive or read said transaction link code from said payee device;
a transaction link code communicating module, executed by said processor, configured to communicate said transaction link code to said payment server;
a payer device ID module, executed by said processor, configured to communicate said device ID of said payer device along with said transaction link code to said payment server;
a payment details receiving module, executed by said processor, configured to receive said payment details from said payment server to make said payment transaction;
a bank accounts detail displaying module, executed by said processor, configured to provide the one or more bank accounts to said payer to select a bank account to make said payment transaction;
a pin or account validation communication module, executed by said processor, configured to communicate encrypted PIN of said selected bank account to said payment server;
a payer validation module, executed by said processor, configured to validate said payer when said payer provides at least one of (i) an encrypted PIN of said selected bank account, and (b) a biometric parameter of said payer; and
a payer transaction confirmation message receiving module, executed by said processor, configured to receive a confirmation message from said payment server on receipt of said payment amount approved by said payer from said payer bank server.

16. The system as claimed in claim 15, wherein said directory service (i) stores identity information of said payee and said payer, (ii) establishes said payer and said payee comprises:
(i) a memory unit that stores (a) a set of modules, and (b) a database; and
(ii) a processor which executes said set of modules, wherein said set of modules comprise:
a bank accounts registration module, executed by said processor, configured to provide an option to (a) said payee bank server, and (b) said payer bank server to register with said directory service;
an account information obtaining module, executed by said processor, configured to obtain account information of (a) said payee from said payee bank server, and (b) said payer from said payer bank server;
a payee account information communication module, executed by said processor, configured to communicate said account information of said payee with said payment server when said payment server requests said directory service; and
a payer account information communication module, executed by said processor, configured to communicate said account information of said payer with said payment server when said payment server requests said directory service,
wherein said payer device may be an ATM, wherein said payer device communicates with at least one of: (i) an E-commerce server, (ii) an M-commerce server, (iii) a point of sale terminal, (iv) a social networking web site, and (v) another payer in a peer to peer present transaction of said payee device to perform said payment transaction.

17. The system as claimed in claim 15, wherein said payment server separately communicates with said payee and said payer to make said payment transaction, wherein said entire payment transaction is performs in a cloud.

18. The system as claimed in claim 15, wherein said payment server tags (i) said device ID of said payee device (ii) said device ID of said payer device, and (iii) account descriptions to said transaction link code to generate a transaction number for said payment transaction.

19. The system as claimed in claim 15, wherein said payment server provides an e-receipt to said payer device with details of entire transaction to track a budget of said payer.

20. A method for authenticating a transaction between a payer and a payee using a payment server comprising:
receiving, using a request processing module, a request from a payee for a transaction link code;
communicating, using a payee account identification module, with a directory services to identify bank account details of said payee;
generating, using a transaction link code generation module, said transaction link code;
receiving, using a transaction link code receiving module, said transaction link code from a payer device;
identifying, using a directory services referencing module, pending validation of said payer by communicating with said directory services;
communicating, using a payment details obtaining module, with a payee device to obtain payment details for said payer;
communicating, using a payment detail communicating module, (a) one or more bank accounts of said payer, and (b) said payment details to said payer device for making a payment transaction;
receiving, using a payer account identification module, at least one of (i) an encrypted pin of a selected bank account from said payer device, and (b) a biometric parameter of said payer;
authorizing, using a payment authorization module, said payment transaction by confirming a payment amount available in said selected bank account of said payer;
communicating, using a payment receiving module, with a payer bank server to receive said payment amount that is approved by said payer using said payer device;
communicating, using payment transferring module, with a payee bank server to transfer said payment amount received from said payer bank server; and
communicating, using a payment confirmation module, a confirmation message to (a) said payer device, and (b) said payee device on receipt of said payment amount.

21. The method as claimed in claim 20, wherein said payee device performs the steps of:
communicating, using a payment transaction initiating module, said request for said transaction link code to said payment server to initiate said payment transaction;
communicating, using a payee device id module, a device id of said payee device along with said request to said payment server;
receiving, using a transaction link code receiving module, said transaction link code from said payment server;
displaying or transmitting, using a transaction link code transmitting module, said transaction link code to said payer device;
receiving, using a payment details transmitting module, a request for payment details from said payment server;
transmitting, using the payment details transmitting module, said payment details to said payment server; and
receiving, using a payee transaction confirmation message receiving module, a confirmation message from said payment server when said payee bank server receives said payment amount from said payment server.

22. The method as claimed in claim 20, wherein said payer device performs the steps of:
reading, using a transaction link code reading module, said transaction link code from said payee device and creates an atmosphere for said payment transaction;
communicating, using a transaction link code communicating module, said transaction link code to said payment server;
communicating, using a payer device id module, a device id of said payer device along with said transaction link code to said payment server;
receiving, using a payment details receiving module, said payment details from said payment server to make said payment transaction;
providing, using a bank accounts detail displaying module, said one or more bank accounts to said payer to select a bank account to make said payment transaction;
communicating, using a pin or account validation communication module, an encrypted pin of a selected bank account to said payment server;
validating, using a payer validation module, said payer when said payer provides at least one of (i) an encrypted pin of said selected bank account, and (b) a biometric parameter of said payer; and
receiving, using a confirmation message receiving module, a confirmation message from said payment server on receipt of said payment amount approved by said payer from said payer bank server.
